(19) United States
(12) Patent Application Publication
(10) Pub. No.: US 2026/0253043 A1
(43) Pub. Date: Aug. 27, 2026

(54) MONITORING A MOVING ELEMENT

(71) Applicant: ODYSIGHT.AI LTD., Omer (IL)

(72) Inventors: Amir GOVRIN, Ramat Gan (IL); Yekaterina DLUGACH, Mabuim (IL); Arik PRIEL, Givat Shmuel (IL); Amit SULTAN, Beer Sheva (IL)

(21) Appl. No.: 18/995,571

(22) PCT Filed: Jul. 31, 2023
(86) PCT No.: PCT/IL2023/050794

§ 371 Date: Jan. 16, 2025

Related U.S. Application Data
(60) Provisional application No. 63/394,161, filed on Aug. 1, 2022.

(51) Int. Cl. G06Q 10/20; F16H 57/01; G01M 13/023; G06T 7/00; G06T 7/13; G06T 7/246

(52) U.S. Cl. CPC G06Q 10/20; F16H 57/01; G01M 13/023; G06T 7/0004; G06T 7/13; G06T 7/248; F16H 2057/014; F16H 2057/018; G06T 2207/10016; G06T 2207/20081; G06T 2207/20084; G06T 2207/30164

(57) ABSTRACT

A system for monitoring a moving element includes processing circuitry. The processing circuitry inputs image data of one or more sections of a moving element from at least one optical sensor. In those section(s), range of motion in a secondary direction of motion of the moving element is determined from the image data. The range of motion is analyzed to determine the health of the moving element and an indicator is output with the results of the analysis. The indicator may trigger operations in other system components, such as a system controller.

### TECHNICAL FIELD

The present disclosure, in some embodiments, thereof, relates to monitoring a moving element, and, more particularly, but not exclusively, to monitoring a fast moving element such as a looped or rotating moving element.

### BACKGROUND

Machine maintenance is important in many fields, including manufacturing, aeronautics, vehicles and many others. Effective maintenance strategies may help prevent failures, enable organizations to meet production schedules, minimize costly downtime, and lower the risk of accidents and injuries.

Machine maintenance may include any work that maintains the mechanical assets running with minimal downtime to the machine and/or the component. Maintenance may also include replacement or realignment of parts that are worn, damaged, or misaligned.

Currently, industrial maintenance is typically scheduled for set periods of time (periodic maintenance), possibly based on factors such as statistical and/or historic data and/or a level of use (for example mileage or the number of hours in operation). Maintenance may also be performed when a machine, part or component fails (breakdown maintenance). This type of maintenance is often wasteful and inefficient.

In some cases, predictive maintenance is also based on signals or other data provided by vibration sensors. However this data is typically is not indicative of the cause of unexpected vibrations and is therefore of limited use in establishing a maintenance protocol.

Moving and/or rotating elements in machines or systems are very common and in many cases are essential for proper operation of the machines or systems. Often, manual inspection and monitoring of these elements is performed by a technician or other maintenance personnel. However, in some cases it is critical that the elements monitored automatically and in real-time, to ensure proper function of the machines or systems and to prevent failure of the machine or systems.

For example, in the case of a pulley belt, monitoring the tension in the belt is usually performed manually while the belt is static (i.e. not moving), for example using a pen gauge that is pressed against the belt and/or using an acoustic stretch meter which measures the tension of the belt according to the self-frequency of the belt. However, in some machines and vehicles, such as unmanned aerial vehicles (UAV), it is critical that the timing belt be monitored in real-time to prevent release of the belt which may cause the UMA to fail.

Thus, there is a need in the art to provide a system and method for monitoring moving elements in real-time.

### SUMMARY OF THE INVENTION

According to some embodiments there is provided a system, a method, and a computer program product for monitoring a moving element.

Some embodiments of the invention presented herein perform image analysis to monitor a moving element with a primary direction of motion. The image data is provided by one or more optical sensors, which capture image data of respective sections of the moving element. In some embodiments, the image data is analyzed to determine the range of motion of the moving element in a secondary direction.

Optionally, the moving element is a looped moving element moving around pulleys. Alternately, the moving element is a rotating moving element which rotates around an axis.

Examples of looped moving elements and rotating moving elements, and their respective primary and secondary directions of motion are presented below.

As used herein the terms “primary direction of motion” and “primary direction” mean the direction in which the moving element moves to perform its function.

As used herein the terms “secondary direction of motion” and “secondary direction” mean a direction in which the moving element moves but is not necessary to perform its function.

In some embodiments of the invention, the image data is used to identify possible problems in physical aspects of the moving element, such as its material composition, structure, shape and so forth.

For example, changes in the thickness of a looped moving element may indicate wear of the looped moving element. In another example, an uneven surface of a looped moving element may indicate a tear or bump. In a further example, a change in the color of the looped moving element may indicate decomposition of the material forming the looped moving element.

In other examples, the image data may be used to detect differences between the shape of a rotating moving element and a previous or desired shape.

Some embodiments of the invention may analyze the image data to monitor failure modes of additional components (i.e. other than the moving element), thereby expanding the capabilities of the monitoring system and method described herein.

Optionally, the image data additionally includes data from optical sensors that are viewing other elements. This image data may be used to analyze the health and/or other parameters related to associated components and/or external factors (such as faults/failures in associated components, whether the system containing the moving element is moving or stationary, operating conditions, etc.).

The range of motion in secondary direction(s) and other factors that may be determined therefrom, may be used to monitor and analyze the operation and/or health of the moving element. When problems are detected, operation of the moving element and/or the system it is a part of may be controlled accordingly to alleviate the detected problem. Results of the analysis may also be used for preventive maintenance purposes, for example to speed up maintenance by early detection of problems that would otherwise be detected only later and/or to prevent unnecessary maintenance when the moving element is in good health.

One aspect of embodiments of the invention relates to monitoring failure modes associated with the tension in a looped moving element. Maintaining the correct tension in the looped moving element may be of great importance to ensure that a machine or system is operating correctly. For example, when the range of motion in the secondary direction is greater than a specified threshold, a looped moving element may be operating below the required tension indicating a fault or failure (e.g. a lengthening of the belt, a in the belt, movement of the pulleys, etc.).

An alternate or additional aspect of embodiments of the invention relates to monitoring failure modes associated with defects in the looped moving element. For example, a fray or tear in the looped moving element may result in bumps or ridges in the surface of the looped moving element which are detectable by analyzing images of sections of the looped moving element.

A further alternate or additional aspect of embodiments of the invention relates to monitoring failure modes associated with a change in the shape of the moving element. For example, a change in shape of a rotating moving element may indicate a deformation of the rotating moving element or breakage of the rotating moving element.

A yet further alternate or additional aspect of embodiments of the invention relates to monitoring failure modes associated with a change in the appearance of the moving element. For example, a change in color, brightness or blurred appearance of the moving element may indicate changes in speed, frequency, acceleration and deceleration of the moving element, in the primary and/or secondary directions of motion.

Optionally, information about the health of the moving element is provided to a predictive maintenance system, such as Prognostic Health Management (PHM), Condition-based Maintenance (CBM) and Health & Usage Monitoring Systems (HUMS).

Monitoring the range of motion of moving element in secondary direction(s) accurately and over time may enable identifying and/or predicting a fault before it has become acute. Thus the occurrence of such faults may be avoided by preventive maintenance.

Some embodiments of the invention provide a technical solution to the technical problem of preventing the operation of the associated system when there is a failure in the moving element. When the analysis identifies a fault in the moving element, the indicator may trigger control operations such as stopping the operation of the associated system and/or otherwise changing operational parameters (e.g. the rate of rotation).

Some embodiments of the invention provide a technical solution to the technical problem of detecting faults early so as to eliminate failures of the system. A technical solution may be to trigger an action such as early maintenance as soon as a fault is detected or even suspected. Early maintenance may prevent future failure.

Some embodiments of the invention provide a technical solution to the technical problem of monitoring a moving element in locations under severe space constraints. A technical solution may be to use a single small optical sensor positioned close to the moving element. For example, an optical sensor positioned 2 cm. from the moving element may capture images of a 1 cm. section of the moving element, which is sufficient to determine the range of motion and identify faults.

Some embodiments of the invention provide a technical solution to the technical problem of monitoring a fast moving element using optical sensors. A technical solution may be the use of a simple optical sensor with a low to average frame rate to enable analysis of blurred images of the fast moving element. Embodiments of the invention relate to analyzing blurred images to receive an indication of a health of the imaged components and their associated elements.

Effects of the invention may include but are not limited to:
1) Early detection of faults and failures;
2) Rapid detection of acute failures;
3) Real-time control of the moving element or associated element in response to a detected fault and/or failure;
4) Preventive and predictive maintenance may be based on the progression of the range of motion over time;
5) Suitable for monitoring many types of systems and devices, including manufacturing machinery, vehicles, aircrafts and many more.
6) May be used in a wide range of environmental conditions.
7) Enables monitoring the moving element in otherwise inaccessible areas by positioning the optical sensor(s) with a view of a moving element or portions thereof that may not be monitored otherwise.

According to a first aspect of some embodiments of the present invention there is provided a system for monitoring a moving element which includes processing circuitry. The processing circuitry is configured to:
input image data of at least one section of a moving element from at least one optical sensor;
determine, from the image data, a range of motion of the at least one section of the moving element in a secondary direction of motion relative to a primary direction of motion of the moving element; and
output an indicator of the health of the moving element based on an analysis of the range of motion.

According to a second aspect of some embodiments of the present invention there is provided method for monitoring a moving element. The method includes:
inputting image data of at least one section of a moving element from at least one optical sensor;
determining, from the image data, a range of motion of the at least one section of the moving element in a secondary direction of motion relative to a primary direction of motion of the moving element; and
outputting an indicator of a health of the moving element based on an analysis of the range of motion.

According to a third aspect of some embodiments of the present invention there is provided a non-transitory storage medium storing program instructions which, when executed by a processor, cause the processor to carry out the method of the second aspect and any embodiments thereof.

According to some embodiments of the invention, the moving element is a rotating moving element, the primary direction of motion is a rotational direction of motion and the secondary direction of motion is a linear direction of motion.

According to some embodiments of the invention, the moving element is a looped moving element, the primary direction of motion is a first longitudinal direction of motion of the looped moving element and the secondary direction of motion is transverse to the first longitudinal direction of motion.

According to some embodiments of the invention, the transverse direction of motion is a second longitudinal direction of motion perpendicular to the first longitudinal direction of motion.

According to some embodiments of the invention, the looped moving element is one of:
a pulley belt;
a cable;
a strap;
a rope; and
a chain.

According to some embodiments of the invention, an operation of the moving element is controlled based on the health of the moving element, so as to prevent operation of the moving element during failure.

According to some embodiments of the invention, the indicator is output to a controller configured to control an operation of the moving element based on the health of the moving element, so as to prevent operation of the moving element during failure.

According to some embodiments of the invention, the indicator is output to a preventive maintenance system configured to provide maintenance instructions based on the indicator.

According to some embodiments of the invention, the indicator is displayed on a user interface so as to alert a user of the health of the moving element.

According to some embodiments of the invention, the indicator includes at least one of:
maintenance instructions;
a time to failure estimation;
a failure alert; and
operating instructions in response to a detected failure.

According to some embodiments of the invention, the moving element is a looped moving element, and wherein for the analysis of the range of motion a larger range of motion is indicative of a lower tension of the moving element relative to a tension at a smaller range of motion.

According to some embodiments of the invention, the analysis includes evaluating the health of the moving element by comparing a magnitude of the range of motion to at least one threshold.

According to some embodiments of the invention, the range of motion is determined by calculating a maximal amplitude of a contour of the moving element in an image captured with an exposure time exceeding an expected time for the moving element to transition over an entire range of motion.

According to some embodiments of the invention, the exposure time is selected so as to blur the moving element within the image data.

According to some embodiments of the invention, the optical sensor is controlled so as to capture the image with the exposure time exceeding an expected time for the moving element to transition over the entire range of motion.

According to some embodiments of the invention, the range of motion is determined based on a statistical analysis of a sequence of image frames.

According to some embodiments of the invention, the image data is a video sequence of images.

According to some embodiments of the invention, the health of the moving element is evaluated based on a change of a magnitude of the range of motion over time.

According to some embodiments of the invention, the health of the moving element is evaluated based on a shape of the at least one section.

According to some embodiments of the invention, the health of the moving element is evaluated based on changes in a shape of the moving element in multiple different sections of the moving element.

According to some embodiments of the invention, image data is input from multiple optical sensors, each of the optical sensors capturing image data of a respective section of the moving element.

According to some embodiments of the invention, image data is input from a single optical sensor at a fixed location relative to the moving element.

According to some embodiments of the invention, at least one of the sections of the moving element includes at least 10% of a length of the moving element.

According to some embodiments of the invention, the indicator is retrieved from a data structure indexed, at least in part, by at least one parameter determinable from the range of motion.

According to some embodiments of the invention, the analysis is based on a machine learning model trained using a training set of images collected during operation of at least one of the moving element and a similar moving element.

According to some embodiments of the invention, the machine learning model is a neural network.

According to some embodiments of the invention, the training of the machine learning model is performed using a supervised learning algorithm.

According to some embodiments of the invention, the training of the machine learning model is performed using an unsupervised learning algorithm.

According to some embodiments of the invention, the analysis includes predicting the future health of the moving element by performing trend analysis on changes in the range of motion over time.

According to a fourth aspect and a fifth aspect of some embodiments of the present invention there are respectively provided a system and method for monitoring condition and/or integrity of operation of a moving and/or rotating element, optionally secured at least at one end thereof to an element stationary with regards to the movement and/or rotation of the element. Optionally the monitoring is performed automatically and/or in real-time and/or during movement of the element. According to a sixth aspect and a seventh aspect of embodiments of the present invention there are respectively provided a system and method for predictive based maintenance of the element.

According to some embodiments of the invention, the system includes at least one optical sensor, such as a camera, configured to be fixed on, in vicinity to, or in sight with a moving and/or rotating element, optionally secured at least at one end thereof to an element stationary with regards to the movement and/or rotation of the element, and at least one processor in communication with the at least one optical sensor. The system may be configured to provide an indication of the condition and/or integrity of operation of the element. Optionally, the use of at least one optical sensor enables to monitor the condition and/or operation of the moving and/or rotating element automatically, during operation and in real-time.

In some embodiments of the invention the moving and/or rotating element is a looped moving element as described herein.

In alternate embodiments of the invention the moving and/or rotating element is a rotating moving element as described herein.

According to some embodiments of the invention, a system for monitoring condition and/or integrity of operation of a moving and/or rotating element, optionally secured at least at one end thereof to an element stationary with regards to the movement and/or rotation of the element, is presented. The system comprises:
at least one optical sensor configured to be fixed on, in vicinity to, and/or in sight with the element and which is configured to capture a plurality of images of the element while in motion;
a processor executable to:
   receive the captured plurality of images from the at least one optical sensor;
   calculate a maximal amplitude of a secondary motion of the element and/or displacement of the element along an axis which is perpendicular to the motion axis and/or the axial and radial motion of the element and/or combination thereof; and
   if the maximal amplitude of the secondary motion and/or displacement of the element is above a predefined threshold, outputting a signal indicative of a fault in the element or associated with the element.

According to some embodiments of the invention, the processor is executable to calculate a maximal amplitude of a secondary motion of the element and/or displacement of the element along the axial and radial motion of the element, by:
measuring in each of the plurality of images a contour, perimeter and structure of traces formed along the movement of the element; and
calculating a maximal deviation of the traces from a known base line of the traces when operating properly.

According to some embodiments of the invention, the system further comprises an illumination source configured to illuminate the element with a pulse of light during capturing of the plurality of images, wherein the pulse duration is shorter than a shutter exposure time of the at least one sensor, and wherein the processor is executable to calculate a maximal amplitude of a secondary motion of the element and/or displacement of the element along an axis which is perpendicular to the motion axis and/or the axial and radial motion of the element and/or combination thereof.

According to some embodiments of the invention, monitoring condition and/or integrity of operation of a moving and/or rotating element comprises monitoring at least one member of the following list:
tension;
tightness;
integrity;
concentration;
straightness;
stability;
dynamic balance;
symmetry;
frequency;
rigidity;
perpendicularity (e.g. Orthogonality or Right-Angle Alignment);
centrality (e.g. Centering or Symmetry);
cylindricality (e.g. Circularity or Roundness);
dimensional stability (e.g. Size Consistency or Geometric Stability);
thermal expansion (e.g. Coefficient of Thermal Expansion (CTE) or Thermal Dilatation);
vibrations (e.g. Mechanical Oscillations or Dynamic Vibrations);
alignments (e.g. Geometrical Alignment or Positioning);
deformations (e.g. Distortions or Geometrical Changes); and/or
alignment of the moving and/or rotating element.

According to some embodiments of the invention, the element is secured at two ends thereof.

According to some embodiments of the invention, the element is a belt connected between two pulleys.

According to some embodiments of the invention, the belt is a toothed belt.

According to some embodiments of the invention, the belt is a timing belt.

According to some embodiments of the invention, the belt is a flat belt.

According to some embodiments of the invention, the element is a shaft.

According to some embodiments of the invention, the element is a rotor, propeller, turbo, fan blades, impeller, turbine blade and/or turbo blade.

According to some embodiments of the invention, the predefined threshold is based on a calculated maximal amplitude of a secondary motion of the element and/or displacement of the element along an axis which is perpendicular to the motion axis and/or the axial and radial motion of the element and/or combination thereof when operating properly.

According to some embodiments of the invention, the processor is further executable to:
apply on the plurality of images a set of faults detection algorithms to detect potential faults in the element or section thereof based on predefined faults detection parameters; and
for a detected fault, output a signal indicative thereof.

According to some embodiments of the invention, the faults detection algorithms are configured to:
obtain data associated with the faults detection parameters of at least one mode of failure of the element; and
identify at least one change in at least one image of the plurality of images in comparison to a given image of the element in a proper condition or in comparison to an image of the element previously obtained;
for an identified change, apply the at least one identified change to an algorithm configured to analyze the identified change and to classify whether the identified change is associated with a mode of failure of the element, thereby labeling the identified change as a detected fault, based, at least in part, on the obtained data; and
for an identified change which is classified as being associated with a mode of failure, outputting a signal indicative of the identified change associated with the mode of failure.

According to some embodiments of the invention, for a detected fault, generate at least one model of a trend in the identified fault.

According to some embodiments of the invention, the trend comprises a rate of change in the fault.

According to some embodiments of the invention, generating the at least one model of trend in the detected fault comprises calculating a correlation of the rate of change of the fault with one or more environmental parameters.

According to some embodiments of the invention, the processor is further configured to alert a user of a predicted failure based, at least in part, on the generated model.

According to some embodiments of the invention, alerting the user of a predicted failure comprises any one or more of a time (or range of times) of a predicted failure, a usage time of the element and characteristics of the mode of failure, or any combination thereof.

According to some embodiments of the invention, the processor is further configured to output a prediction of when the detected fault is likely to lead to failure in the element, based at least in part, on the generated model.

According to some embodiments of the invention, the prediction of when a failure is likely to occur in the element is based, at least in part, on known future environmental parameters.

According to some embodiments of the invention, obtaining data associated with faults detection parameters of at least one mode of failure of the element comprises data associated with a location of the fault on element and/or a specific type of mode of failure.

According to some embodiments of the invention, obtaining data associated with faults detection parameters of at least one mode of failure of the element comprises receiving inputted data from a user.

According to some embodiments of the invention, obtaining data associated with faults detection parameters of at least one mode of failure of the element comprises identifying a previously unknown failure mode by applying the plurality of images or part thereof to a machine learning algorithm configured to determine a mode of failure of the element.

According to some embodiments of the invention, a method for monitoring condition and/or integrity of operation of a moving and/or rotating element, optionally secured at least at one end thereof to an element stationary with regards to the movement and/or rotation of the component, is presented. The method comprises the steps of:
capturing a plurality of images of the element while in motion utilizing at least one optical sensor;
receiving, by a processor, the captured plurality of images from the at least one optical sensor;
calculating a maximal amplitude of a secondary motion of the element and/or displacement of the element along an axis which is perpendicular to the motion axis and/or axial and radial motion of the element and/or combination thereof; and
if the maximal amplitude of the secondary motion of the element and/or displacement of the element is above a predefined threshold, outputting a signal indicative of a fault in the element or associated with the element.

According to some embodiments of the invention, calculating a maximal amplitude of a secondary motion of the element and/or displacement of the element along an axis which is perpendicular to the motion axis and/or axial and radial motion of the element, comprises the steps of:
applying trace detection algorithms to each of the plurality of images for measuring a contour, perimeter and structure of the traces formed along the movement of the element; and
calculating a maximal deviation of the traces from a known base line of the traces when operating properly.

According to some embodiments of the invention, the method further comprises the steps of:
illuminating the element with pulses of light by an illumination source during capturing of the plurality of images, wherein the pulses durations are shorter than a shutter exposure time of the at least one sensor;
calculating a maximal amplitude of a secondary motion of the element and/or displacement of the element along an axis which is perpendicular to the motion axis and/or axial and radial motion of the element and/or combination thereof.

According to some embodiments of the invention, monitoring condition and/or operation of a moving and/or rotating element comprises monitoring at least one member of the following list:
tension;
tightness;
integrity;
concentration;
straightness;
stability;
dynamic balance;
symmetry;
frequency;
rigidity; and/or
alignment of the moving and/or rotating element.

According to some embodiments of the invention, the method further comprising the steps of:
applying on the plurality of images a set of faults detection algorithms to detect potential faults in the element or section thereof based on predefined faults detection parameters; and
for a detected fault, output a signal indicative thereof.

According to some embodiments of the invention, the faults detection algorithms are configured to:
obtain data associated with the faults detection parameters of at least one mode of failure of the element; and
identify at least one change in at least one image of the plurality of images in comparison to a given image of the element in a proper condition or in comparison to an image of the element previously obtained;
for an identified change, apply the at least one identified change to an algorithm configured to analyze the identified change and to classify whether the identified change is associated with a mode of failure of the element, thereby labeling the identified change as a detected fault, based, at least in part, on the obtained data; and
for an identified change which is classified as being associated with a mode of failure, outputting a signal indicative of the identified change associated with the mode of failure.

According to some embodiments of the invention, features of the first, second, third, sixth and seventh aspects of the invention may be combined. For example, optical sensors, illumination means and processors described with any of the aspects may be provided with any of the other aspects.

Unless otherwise defined, all technical and/or scientific terms used within this document have meaning as commonly understood by one of ordinary skill in the art/s to which the present disclosure pertains. Methods and/or materials similar or equivalent to those described herein can be used in the practice and/or testing of embodiments of the present disclosure, and exemplary methods and/or materials are described below. Regarding exemplary embodiments described below, the materials, methods, and examples are illustrative and are not intended to be necessarily limiting.

Some embodiments of the present disclosure are embodied as a system, method, or computer program product. For example, some embodiments of the present disclosure may take the form of an entirely hardware embodiment, an entirely software embodiment (including firmware, resident software, micro code, etc.) or an embodiment combining software and hardware aspects that may all generally be referred to herein as a “circuit,” “module” and/or “system.”

Implementation of the method and/or system of some embodiments of the present disclosure can involve performing and/or completing selected tasks manually, automatically, or a combination thereof. According to actual instrumentation and/or equipment of some embodiments of the method and/or system of the present disclosure, several selected tasks could be implemented by hardware, by software or by firmware and/or by a combination thereof, e.g. using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computational device e.g., using any suitable operating system.

In some embodiments, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage e.g., for storing instructions and/or data. Optionally, a network connection is provided as well. User interface/s e.g., display/s and/or user input device/s are optionally provided.

Some embodiments of the present disclosure may be described below with reference to flowchart illustrations and/or block diagrams. For example illustrating exemplary methods and/or apparatus (systems) and/or computer program products according to embodiments of the present disclosure. It will be understood that each step of the flowchart illustrations and/or block of the block diagrams, and/or combinations of steps in the flowchart illustrations and/or blocks in the block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart steps and/or block diagram block or blocks.

These computer program instructions may also be stored in a computer readable medium that can direct a computer (e.g., in a memory, local and/or hosted at the cloud), other programmable data processing apparatus, or other devices to function in a particular manner, such that the instructions stored in the computer readable medium can be used to produce an article of manufacture including instructions which implement the function/act specified in the flowchart and/or block diagram block or blocks.

The computer program instructions may also be run by one or more computational device to cause a series of operational steps to be performed e.g., on the computational device, other programmable apparatus and/or other devices to produce a computer implemented process such that the instructions which execute provide processes for implementing the functions/acts specified in the flowchart and/or block diagram block or blocks.

### BRIEF DESCRIPTION OF THE DRAWINGS

In order to understand the invention, embodiments will now be described, by way of non-limiting example only, with reference to the accompanying drawings. Features shown in the drawings are meant to be illustrative of only some embodiments of the invention, unless otherwise indicated. In the drawings like reference numerals are used to indicate corresponding parts.

In block diagrams and flowcharts, optional elements/components and optional stages may be included within dashed boxes.

In the figures:

FIGS. 1A-1B are simplified illustrations of looped moving elements looped over two and three pulleys respectively;

FIG. 2A is a simplified illustration of a single optical sensor positioned to capture side view images of a section of a pulley belt, in accordance with respective embodiments of the present invention;

FIG. 2B is a simplified illustration of two optical sensors positioned to capture side view images of respective sections of a pulley belt, in accordance with respective embodiments of the present invention;

FIGS. 3A-4 are simplified block diagrams of a monitoring system for monitoring a looped moving element, in accordance with respective embodiments of the present invention;

FIGS. 5A-5C are simplified exemplary illustrations of a side view of a looped moving element at respective points in time;

FIG. 5D is a simplified side view illustrating the range of motion of the looped element of FIGS. 5A-5C during a time period;

FIG. 5E is a simplified side view illustrating the range of secondary motion of a section of the looped element during a time period;

FIGS. 6A-6C are simplified exemplary illustrations of a top view of a looped moving element at respective points in time;

FIG. 6D is a simplified top view illustrating the range of lateral motion of a section of the looped element during a time period;

FIG. 6E is a simplified side view illustrating a wavelike range of motion of a looped element;

FIGS. 6F-6H are simplified schematic illustrations of examples of a rotating moving element;

FIGS. 7-8 are simplified flowcharts of methods for monitoring a looped moving element, according to respective embodiments of the invention;

FIG. 9 is a schematic illustration of a system for monitoring potential failure in a moving and/or rotating element in accordance with some exemplary embodiments of the present invention;

FIG. 10 is a simplified flowchart of a computer implemented method for monitoring potential failure in a moving element, in accordance with some exemplary embodiments of the present invention;

FIG. 11 is a simplified schematic block diagram of a method for monitoring potential failure in a moving element, in accordance with some exemplary embodiments of the present invention;

FIG. 12 is a schematic block diagram of the system for monitoring potential failure in a moving element, in accordance with some exemplary embodiments of the present invention;

FIG. 13 is a simplified block diagram of a system for monitoring condition and/or integrity of operation of a moving element, according to some exemplary embodiments of the invention;

FIG. 14 is a simplified flowchart of a method for monitoring the condition and/or integrity of operation of a moving element, in accordance with some embodiments of the present invention; and

FIGS. 15A-15B are simplified schematic illustrations of monitoring the tightness and/or tension of a belt which is connected between two pulleys, according to respective exemplary embodiments of the invention.

The various embodiments of the present invention are described below with reference to the drawings, which are to be considered in all aspects as illustrative only and not restrictive in any manner.

Elements illustrated in the drawings are not necessarily to scale, emphasis instead being placed upon clearly illustrating the principles of the invention. Moreover, two different objects in the same figure may be drawn to different scales.

### DETAILED DESCRIPTION OF EMBODIMENTS

The present disclosure, in some embodiments, thereof, relates to monitoring a moving element, and, more particularly, but not exclusively, to monitoring a fast moving element such as a looped or rotating moving element.

In some embodiments of the invention the moving element is a looped moving element as described above, and the term “secondary motion” means motion that is not in the longitudinal direction of motion of the looped moving element.

In alternate embodiments of the invention the moving element is a rotating moving element as described above, and the term “secondary motion” means motion that is not in the rotational direction of motion of the rotating moving element.

According to embodiments of the invention, a looped moving element is a mechanical element that is looped over one or more pulleys, typically to transfer power from one rotating shaft to another. Another use for a looped moving element is providing a source of motion (for example as a conveyor belt). Looped moving elements are often formed from a flexible material, such as plastic or rubber. However, cables, straps, ropes, chains and the like may also be used.

Looped moving elements may be looped over two or more pulleys and may be flat or crossed. The longitudinal direction of motion of the looped moving element depends on the relative positions of the pulleys and differs along different sections of the looped moving element.

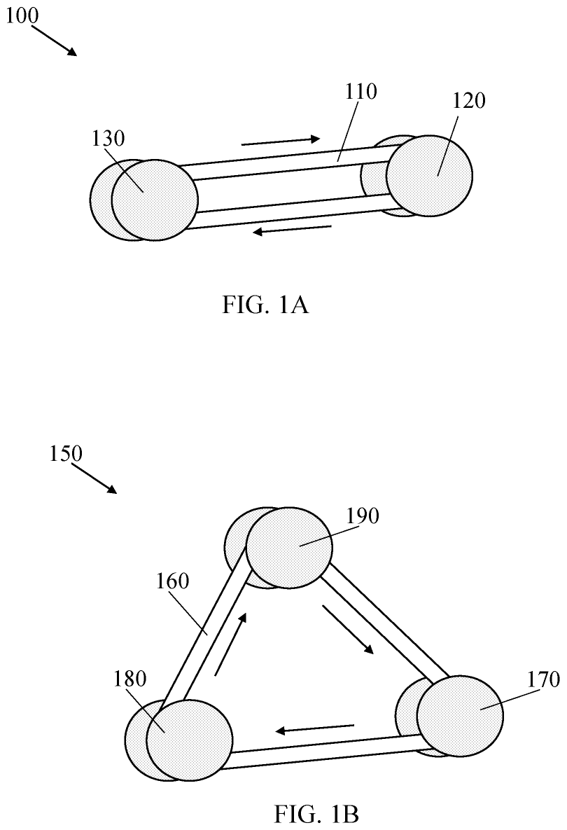

Reference is now made to FIG. 1A, which is a simplified illustration of an exemplary two-pulley system 100 with pulley belt 110. Pulley belt 110 is looped over two pulleys, 120 and 130. For purposes of explanation, pulley belt 110 is considered to be moving in a clockwise direction. As illustrated by the arrows, the top and bottom portions of pulley belt 110 move in opposite longitudinal directions.

Reference is now made to FIG. 1B, which is a simplified illustration of an exemplary three-pulley system 150 with pulley belt 160. Pulley belt 160 is looped over three pulleys, 170, 180 and 190. For purposes of explanation, the pulley belt is considered to be moving in a clockwise direction. As illustrated by the arrows, the longitudinal direction of the pulley belt between each pair of pulleys is different over different portions of pulley belt 110.

In the non-limiting examples of FIGS. 1A-1B, pulleys 120, 130, 170, 180 and 190 are all illustrated as being of the same size, however other systems may have pulleys with differing sizes and/or positioned at non-symmetrical distances from each other.

Some embodiments presented herein analyze image data captured of a looped moving element to accurately monitor the operation and health of the looped moving element. The analysis may detect immediate problems and/or predict future problems in the looped moving element and/or associated elements.

The image data is captured by one or more optical sensors positioned with a view of the looped moving element or a section thereof.

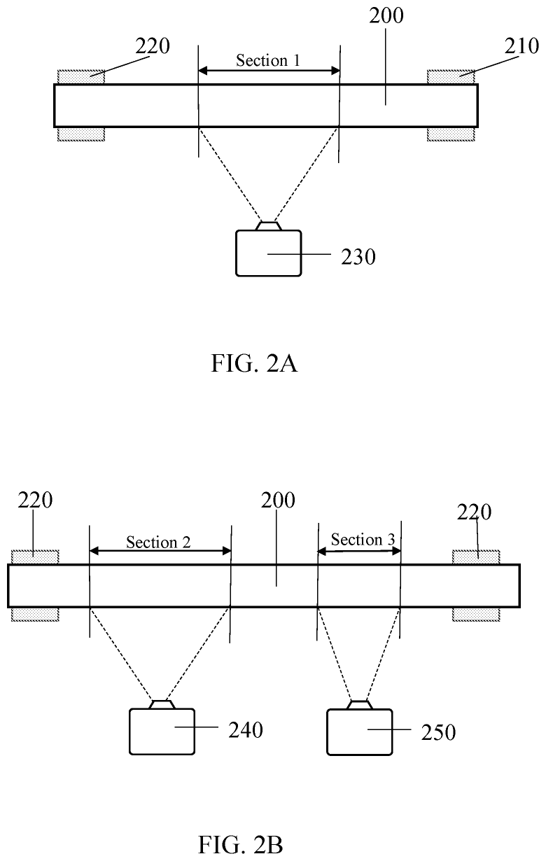

Reference is now made to FIG. 2A, which is a simplified illustration of a single optical sensor positioned to capture side view images of a section of a pulley belt, according to an exemplary embodiment of the invention. Pulley belt 200 is looped over pulleys 210 and 220. FIG. 2A illustrates a view from above pulley belt 200 looking downward, with optical sensor 230 collecting image data of Section 1 from the side of the belt 200.

Reference is now made to FIG. 2B, which is a simplified illustration of two optical sensors positioned to capture side view images of respective sections of a pulley belt, according to an exemplary embodiment of the invention. Pulley belt 200 is looped over pulleys 210 and 220. Optical sensor 240 collects image data of Section 2 and optical sensor 250 collects image data of Section 3.

Some embodiments of the invention presented herein monitor the operation of a looped moving element (and/or an associated element) during operation. Optionally, the monitoring is continuous, or in response to detected faults, failure modes and/or failures in the looped moving element and/or associated element(s).

As used herein, according to some embodiments of the invention, the term “moving element” means an element configured to move in a substantially continuous repetitive motion.

As used herein, according to some embodiments of the invention, the term “fast moving element” means a moving element moving at a speed at which the optical sensor used is too slow to capture a sharp image of the moving element. The term “fast moving element” encompasses both looped moving elements and rotating moving elements.

As used herein, according to some embodiments of the invention, the terms “pulley belt” and “belt” mean a loop of flexible material looped over two or more pulleys. Examples of pulley belts are presented below.

As used herein, according to some embodiments of the invention, the term “associated element” means any element whose performance and/or health is affected by the looped moving element. Examples of such elements may include but are not limited to peripheral components, machines, vehicles, mechanisms and/or other types of systems not explicitly listed here.

As used herein, according to some aspects of the invention, the terms “longitudinal direction of motion” and “longitudinal direction” mean the direction in which a looped moving element travels from one pulley to the following pulley in the loop.

As used herein, according to some aspects of the invention, the term “transverse direction” means a direction at an angle to the longitudinal direction of motion of a looped moving object (i.e. a secondary direction of motion of the looped moving object). For example, a vibration in a pulley belt moving in a horizontal longitudinal direction may be seen from a side view as a motion of the belt in a secondary (e.g. vertical) direction. In another example, a slippage of a rope on a pulley may be seen from above as a lateral motion along the width of the pulley.

As used herein, according to some aspects of the invention, the terms “range of motion in the secondary direction” and “range of motion” means the maximal amplitude of the motion of the moving object in the secondary direction over a period of time (e.g. the exposure time of an image or the length of a video sequence of images).

As used herein, according to some embodiments of the invention, the term “image data” means any output of the optical sensor, including images and/or data associated with the images, which may be processed to estimate the secondary range of motion.

As used herein, according to some embodiments of the invention, the term “optical sensor” means a device which senses an optical signal and in response outputs an electronic signal. Optionally, the optical sensor is a camera, and the output signal is an image. Alternately or additionally, the electronic signal output by the optical sensor is processed to form the image data.

As used herein, according to some embodiments of the invention, term “optical signal” encompasses ultraviolet (UV), visible and infrared (IR) radiation and electromagnetic radiation in other frequency bands.

An optical sensor may include filter coatings for all or portion(s) of the spectrum of visible wavelengths and non-visible wavelengths.

As used herein, according to some embodiments, the term “fault” refers to an anomaly or undesired effect or process in the looped moving element and/or pulleys and/or associated elements (such as a machine that the looped moving element is a part of) that may or may not develop into a failure but requires follow-up, to analyze whether any components should be repaired or replaced. According to some embodiments, the fault may include, among others, a change in length (increase or decrease), structural deformation, surface deformation, a crack, crack propagation, a defect, inflation, bending, wear, corrosion, a change in color, a change in appearance and the like, or any combination thereof.

As used herein, according to some embodiments of the invention, the term “failure” refers to any problem that may cause the looped moving element and/or pulleys and/or associated elements to not operate as intended. In some cases a failure may disable usage of the looped moving element and/or pulley(s) and/or other associated element(s) or even pose a danger to the associated element or user.

As used herein, according to some embodiments of the invention, the term “failure mode” is to be widely construed to cover any manner in which a fault or failure may occur, such as a tear (partial or complete), a detachment of the looped moving element from the pulleys, a movement of the pulleys from their correct position, a dislocation of the belt, a change in shape (e.g. length), a structural deformation, surface deformation, a crack, crack propagation, a defect, inflation, bending, wear, corrosion, a change in color, a change in appearance, and the like, or any combination thereof. It is appreciated that a part may be subject to a plurality of failure modes, related to different characteristics or functionalities thereof.

Some failure modes may be common to different element types, while others may be more specific to one or more element types. For example, tears may be relevant to a pulley belt, bending may be relevant to a pulley axle and a corrosion failure mode may be relevant to a chain.

For example, a failure mode of a looped moving element according to embodiments of the present invention may be an increase in the length of the looped moving element, indicating a decreased tension in the looped moving element. Depending on the length of the looped moving element, a fault could be a slight extension, such as a 1 cm. change, and a failure could be a severe extension, such as a 10 cm. change.

As used herein, according to some embodiments of the invention, the term “trend” is to be widely construed to cover any behavior over time of a fault, or a failure mode, when or under what circumstances the fault will turn into a failure. The trend is optionally associated with additional circumstances such as environmental conditions, usage characteristics of the device, characteristics of a user of a device, or the like.

As used herein, according to some embodiments of the invention, the terms “real-time” and “real-time control” mean within a time period short enough to enable a response while the machine in which the moving element is installed is still in operation. The duration of the time period is typically very short, and optionally is specified or otherwise determinable.

The maximum time period that is suitable for real-time control depends on the implementation. Input of the image data and output of the indicator are performed during operation, with the goal of preventing failure by enabling continuous operation until maintenance may be performed (if necessary).

Examples of real-time control include but are not limited to:
i. Less than 10 seconds from output of the indicator;
ii. Less than a minute from output of the indicator; and
iii. Less than the estimated time period until failure.

The principles, uses and implementations of the teachings herein may be better understood with reference to the accompanying description and figures. Upon perusal of the description and figures present herein, one skilled in the art will be able to implement the teachings herein without undue effort or experimentation.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

For purposes of clarity, some embodiments of the invention are illustrated and described with a pulley belt serving as the looped moving element. However, the use of a pulley belt as the looped moving element is non-limiting and other types of elements may be used to the extent possible for the particular embodiment.

### I. MONITORING SYSTEMS

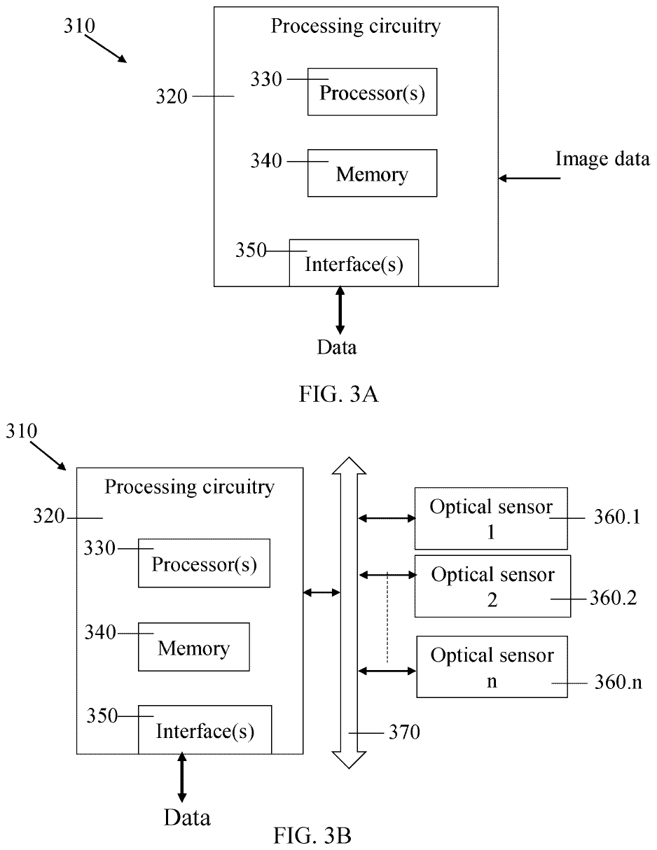

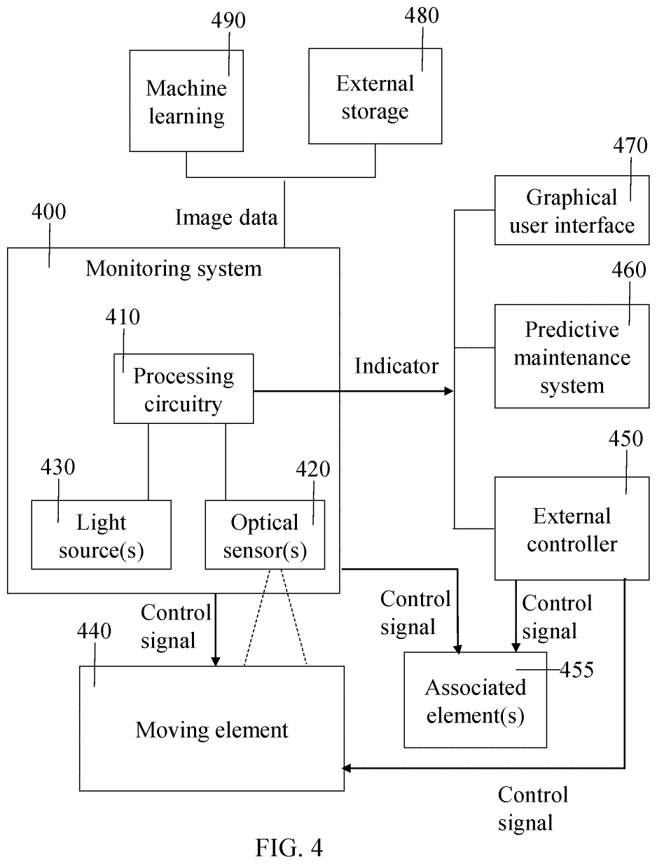

Reference is now made to FIGS. 3A-4, which are simplified block diagrams of a monitoring system for monitoring a moving element, in accordance with respective embodiments of the present invention.

As described below, embodiments of the monitoring system may be employed for many purposes including but not limited to:
1) Monitoring the health of the moving element;
2) Monitoring the functioning and/or health of an element associated with the moving element (e.g. pulley, rotating shaft, machine, vehicle, aircraft, Heating, Ventilation, and Air Conditioning system, manufacturing system etc.);
3) Predicting potential failure of the looped moving element;
4) Predicting potential failure of the associated element or peripheral component; and
5) Determining when maintenance is or will be required for one or more of the moving element, associated element, mechanism, machine etc.

As used herein, according to some embodiments, the term “health” of an element means the overall state, functionality and condition of that specific element. It encompasses the evaluation of various operational parameters, metrics or data points that indicate the element's current status, performance, ability to operate as intended and prediction of future operation and status.

In some embodiments, at least some of the operational parameters, metrics and/or data points used to evaluate the health of an element are based on instructions and/or guidelines provided by a manufacturer, user etc.

In accordance with the embodiments of FIG. 3A, monitoring system 310 for monitoring a moving element includes processing circuitry 320. Processing circuitry 320 includes one or more processors 330, and optionally additional electronic circuitry. Processor(s) 330 process the image data and perform the analyses described herein. Processor(s) 330 may also perform other tasks, such as storing image data to memory, providing a graphical user interface (GUI) to a user, processing inputs from the GUI and/or other input/output means and exporting data to an external system (e.g. a controller of the monitored system, a remote computing platform and/or a predictive health maintenance system).

Processor(s) 330 may include one or more of a Central Processing Unit (CPU), a Graphic Processing Unit (GPU), a Tensor Processing Unit (TPU), a microprocessor, an electronic circuit, an Integrated Circuit (IC) or the like.

Optionally, the processing circuitry is in communication with the optical sensor(s) by wireless communication (e.g., Bluetooth, cellular network, satellite network, local area network, etc.) and/or wired communication (e.g., telephone networks, cable television or internet access, and fiber-optic communication, etc.).

In some embodiments, processing circuitry 320 is located at a single location as shown for clarity in FIGS. 3A-3B.

In alternate embodiments, the processing circuitry is distributed in multiple locations. Optionally, at least one optical sensor includes processing circuitry which performs at least some of the processing described herein.

Optionally, some or all of the processing circuitry is located remotely, for example in the controller of the monitored moving element.

Optionally monitoring system 310 further includes memory 340 for internal storage of data for use by monitoring system 310. Memory 340 may be a hard disk drive, a Flash disk, a Random Access Memory (RAM), a memory chip, or the like.

The stored data may include but is not limited to:
a) Image data;
b) Data associated with the image(s). Examples of associated data may include but are not limited: to the time of image capture, environmental conditions at time of image capture, operational parameters of the machine/device/system in which the moving element is operating and other parameters;
c) Program instructions for execution by processor(s) 330;
d) Algorithms and rules for monitoring a moving element;
e) Failure modes of moving elements; and
f) A model of the mechanism, optionally developed by machine learning from a training set of images of the mechanism or similar mechanism(s). For example, the model may input images of sections of the moving element and output one or more of the range of motion in a secondary direction, the health of the moving element, the health of an element utilizing the moving element, a failure alert, maintenance instructions, etc.

In some embodiments, data produced by monitoring system 310 is exported to one or more external platforms, stored on cloud storage, or the like.

Optionally, processing circuitry 320 further includes one or more interface(s) 350 for inputting and/or outputting data. For example, the interface may serve to input image(s) and/or communicate with other components in a machine and/or to communicate with external machines or systems and/or to provide a user interface.

In one example, indicators and information about the moving element, associated elements and so forth are provided via interface(s) 350 to a HUMS, CBM or similar system.

In accordance with the embodiments of FIG. 3B, monitoring system 310 further includes one or more optical sensors 360.1-360.n, which provide the image data used to monitor the moving element. Optionally, optical sensors 360.1-360.n provide the image data to processing circuitry 320 over databus 370.

According to some embodiments, optical sensors 360.1-360.n may include a camera. According to some embodiments, optical sensors 360.1-360.n may include an electro-optical sensor. According to some embodiments, optical sensors 360.1-360.n may include any one or more of a charge-coupled device (CCD), a light-emitting diode (LED) and a complementary metal-oxide-semiconductor (CMOS) sensor (or an active-pixel sensor), a photodetector (e.g. IR sensor, visible light senor, UV sensor), a distance measurement sensor such as a Lidar sensor, or any combination thereof. According to some embodiments, optical sensors 360.1-360.n may include any one or more of a point sensor, a distributed sensor, an extrinsic sensor, an intrinsic sensor, a through beam sensor, a diffuse reflective sensor, a retro-reflective sensor, or any combination thereof.

Optionally, processing circuitry 310 controls the operation of one or more of the optical sensor(s). Aspects of optical sensor operation which may be controlled include but are not limited to:
1) Time of image capture;
2) Exposure time/frame rate;
3) Field of view;
4) Turning the optical sensor on and off (for example, turning of the optical sensor when the moving element is not operational).

Optionally, processing circuitry 320 controls one or more light sources, where each light source illuminates at least a portion of the mechanism. Optionally, each light source is focused on a specific component or reference point, which may enable reducing the required intensity of the light.

Alternately or additionally, the light source(s) are controlled by a user.

Optionally, the wavelength of the light source may be controlled by processing circuitry 320 and/or a user.

Optionally, the light sources may be configured to illuminate the moving element and/or sections thereof.

By controlling the light sources, processing circuitry 320 and/or the user may improve the image characteristics to ease image processing and analysis. For example, a light source may be adjusted to increase contrast between the moving element and its surroundings. Alternately or additionally, a light source may be adjusted to ease detecting faults and/or surface defects and/or structural defects by increasing shadows that highlight such areas.

According to some embodiments, the light source(s) include one or more of: a light bulb, a light-emitting diode (LED), a laser, an electroluminescent wire, and light transmitted via a fiber optic wire or cable (e.g. from an LED coupled to the fiber optic cable). Other types of light sources may also be suitable.

Optionally, processing circuitry 320 controls one or more of:
1) The direction of illumination of the light source;
2) The duration of illumination;
3) The frequency of illumination;
4) The illumination intensity;
5) Switching the light source on or off (e.g. synchronizing the illumination with the times of image capture by the optical sensor, possibly to create a strobe light effect); and
6) Changing the wavelength of illumination.

According to some embodiments, the light source may emit visible light, infrared (IR) radiation, near IR radiation, ultraviolet (UV) radiation or light in any other spectrum or frequency range which is viewable by at least one optical sensor.

Optionally, at least one optical sensor includes filter coatings for all visible and non-visible wavelengths.

According to some embodiments, a light source is a strobe light or a light source configured to illuminate in short pulses. According to some embodiments, the light source may be configured to emit strobing light without use of a shutter (such as a global shutter, rolling shutter, shutter or any other type of shutter).

Using a strobe light may be particularly useful when it is desired to obtain a clear image of a fast moving object (such as a moving object with a fast longitudinal speed), optionally as described in U.S. Provisional Pat. Appl. No. 63/394,150, and in U.S. Provisional Pat. Appl. No. 63/521,140 and corresponding PCT application filed on same date of the present PCT application which are all incorporated by reference in their entireties into the specification. It may be easier to identify defects such as tears and localized changes in the belt surface in a clearer image.

Optionally, processing circuitry 320 selects respective optimal settings for the light source(s) based on a predefined algorithm. Optionally, the light source is controlled in accordance with the environment the system being monitored is currently operating in. For example, the light source may be turned on during nighttime operation and turned off during daylight.

Optionally, processing circuitry 320 changes the light source operation dynamically during operation. For example, by using different fibers of a fiber optic cable to emit the light at different times or by emitting light from two or more fibers at once.

Optionally, the light sources are part of monitoring system 310.

According to some embodiments, the one or more optical sensors may include one or more lenses and/or a fiber optic sensor. According to some embodiments, optical sensors 360.1-360.n may include a software correction matrix configured to generate an image from the optical sensor output signal. According to some embodiments, the one or more optical sensors may include a focus sensor configured to enable the optical sensor to adjust its focus based on changes in the obtained data. According to some embodiments, the focus sensor may be configured to enable the optical sensor to detect changes in one or more pixels of the obtained signals. Optionally, the changes in the focus may be used as further input data for processing circuitry 320.

Reference is now made to FIG. 4, which is a simplified block diagram of a system for monitoring a moving element, according to embodiments of the invention. FIG. 4 also illustrates external components that monitoring system 400 may communicate with as described below.

Monitoring system 400 includes processing circuitry 410. Optionally, monitoring system 400 includes one or more optical sensors 420 and/or one or more light sources 430.

Processing circuitry 410 inputs image data of at least one section of moving element 440 from optical sensor(s) 420. Processing circuitry 410 determines the range of motion of the section or sections of moving element 440 in one or more secondary directions from the image data. Processing circuitry 410 outputs an indicator of the health of moving element 440 based on an analysis of the range of motion in the secondary direction(s). Optional embodiments are described in more detail below.

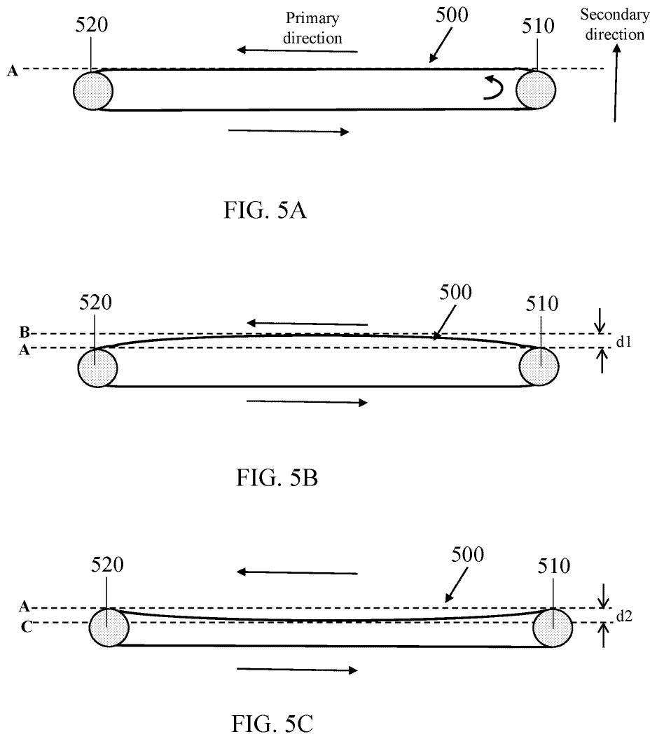

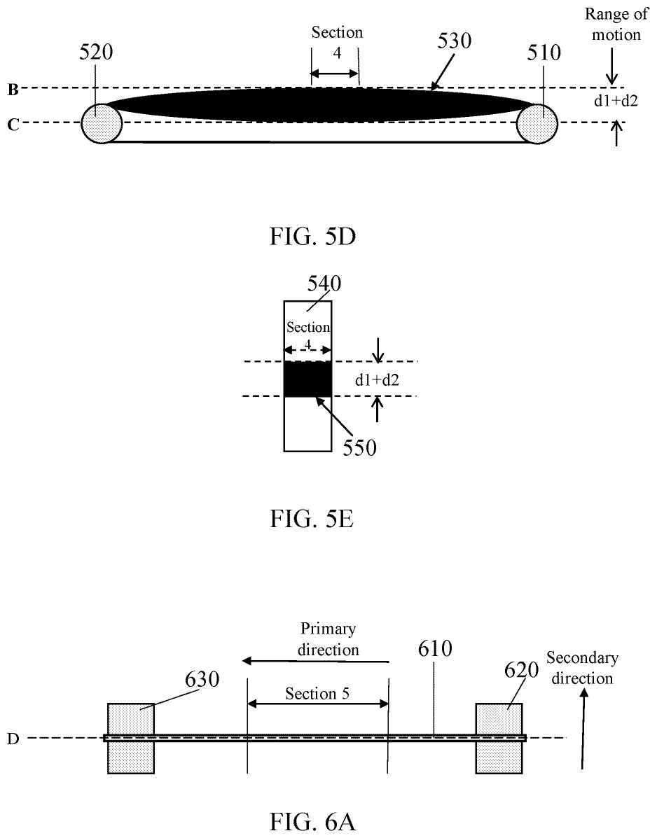

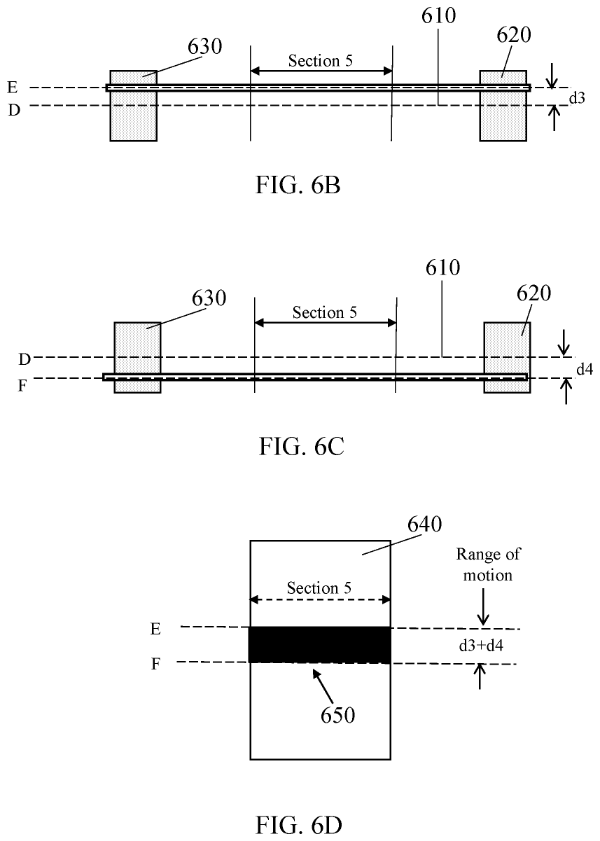

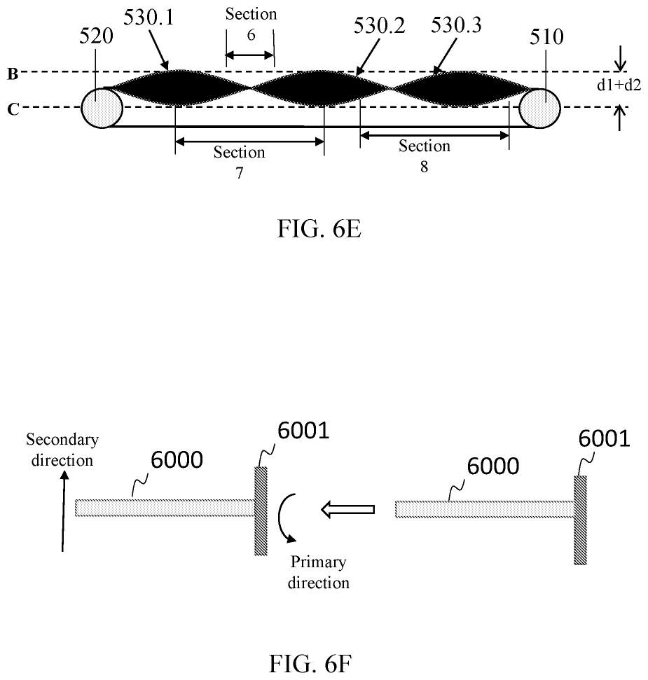

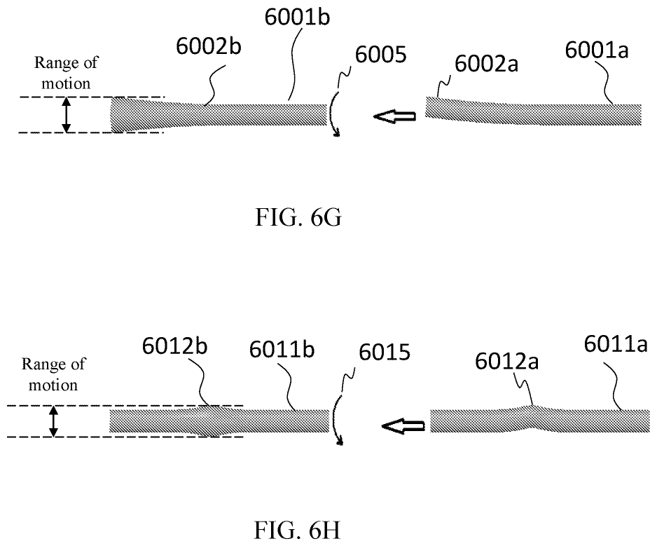

Optionally, the moving element is a looped moving element, and the secondary direction of motion is perpendicular to the longitudinal direction of motion (i.e. the primary direction of motion), as illustrated for example in FIGS. 5A and 6A (described below).

Optical sensor(s) 420 capture image data for respective sections of moving element 440.

Optionally, processing circuitry 410 inputs image data from a single optical sensor at a fixed location relative to moving element 440. In alternate optional embodiments, processing circuitry 410 inputs image data from multiple optical sensors, where each of the optical sensors captures image data of a respective section of moving element 440.

Optionally, at least one of the sections is at least 1%, 5%, 10%, 25% or 50% of the total length of the moving element. Further optionally, at least one of the sections is between 1%-10%, between 10%-20% or between 1%-50% of the total length of the moving element.

Optionally, processing circuitry 410 controls optical sensor(s) 420, substantially as described above.

Optionally, processing circuitry 410 controls light source(s) 430, substantially as described above.

Optionally, processing circuitry 410 determines whether moving element 440 is or is not in motion and/or the speed the moving element 440 is traveling at. Further optionally, processing circuitry 410 determines whether moving element 440 is in motion based on information obtained from one or more of: another sensor (e.g. a motion sensor), and/or a system controller and/or by analysis of the image data (e.g. a blurred image may indicate that moving element 440 is in motion while a clear image may indicate that moving element 440 is static).

When the moving element is a looped moving element, the system controller may provide data indicating what section of the looped moving element is in the optical sensor's field of view at a given time.

Optionally, processing circuitry 410 controls the timing of image data capture (i.e. the optical sensors) based on the speed of moving element 440. For example, images may be captured only while moving element 440 is moving. Alternately or additionally, image capture may be timed to capture images of the entire moving element 440 or of selected sections thereof.

Optionally, the image data is tagged with information about the operational status of moving element 440 and/or associated elements, such as whether moving element 440 is in operation and/or the speed of moving element 440. The tags may be of use during analysis of the image data and/or for machine learning purposes. Optionally, the tags are displayed to a user on GUI 470.

Optionally, monitoring system 400 includes additional elements, such as a memory and/or interfaces (described with reference to FIGS. 3A-3B) but are not shown in FIG. 4 for the purpose of clarity.

Optionally, monitoring system 400 provides the indicator to one or more external systems and/or devices which take action based on the information contained in the indicator.

Optionally, monitoring system 400 provides the indicator to external controller 450. Optionally, external controller 450 analyzes the data contained in the indicator and performs selected control actions when its analysis shows that such control actions are necessary. Alternately or additionally, monitoring system 400 selects the control actions that should be performed (or are recommended) and instructs external controller 450 to perform them.

External controller 450 may control moving element 440 and/or associated element(s) 455, such as a machine or vehicle containing moving element 440, elements in the vicinity of moving element 440, elements connected to moving element 440, and so forth. Further optionally, the control actions prevent operation of moving element 440 when a failure is detected.

Optionally, monitoring system 400 provides the indicator to predictive maintenance system 460. Predictive maintenance system 460 analyzes the data contained in the indicator along with additional data such as previously received indicators, manufacturer specifications, operational information (e.g. the time periods moving element 440 was in operation, environmental conditions, etc.). Based on this analysis, predictive maintenance system 460 provides maintenance instructions for moving element 440 and/or associated element(s) 455.

Optionally, monitoring system 400 provides the indicator for display on graphical user interface (GUI) 470. The indicator may alert a user to detected faults, failures, trends and/or modes of failure in moving element 440. The indicator may also alert the user that action is required to maintain proper operation of moving element 440 and/or associated element(s) 455.

Optionally, monitoring system 400 provides control signals to moving element 440 and/or associated element(s) 455 to perform control actions on the moving element 440 and/or associated element(s) 455 directly. The appropriate control action is selected based on a further analysis of the information in the indicator. Further optionally, the control actions prevent operation of moving element 440 when a failure is detected.

Optionally, monitoring system 400 outputs image data, and optionally other data (such as analysis results, labels, etc.), to external storage 480.

Optionally, monitoring system 400 outputs image data, and optionally other data, to machine learning system 490. Machine learning system 490 may update the training set for modeling the moving element using the new image data (and/or with analysis results, labels, etc.). The updated training set may then be used to retrain the model.

Optionally, image data is not input for periods of time that moving element is not in operation. Alternately or additionally, image data is also input when the moving element is idle and/or not in operation in order to form a baseline for comparison with images captured during operation.

Optionally, the range of motion analysis is performed by the processing circuitry only on image data collected during operation. Data may be input continuously from the optical sensors but not all data will be analyzed by the monitoring system. Image data collected during periods of non-operation may be discarded or may be exported by the monitoring system to external systems (e.g. to an external controller) and/or for external storage (e.g. to cloud storage).

### II. LOOPED MOVING ELEMENT

Optionally, the looped moving element is a pulley belt. Many types of pulley belts are used in various mechanisms, machinery, vehicles, etc. Examples of pulley belts include:
1. V-Belts-a trapezoidal cross-section belt designed to fit into V-shaped pulleys. V-belts are used in various applications, such as automotive engines, industrial machinery, and HVAC (Heating, Ventilation, and Air Conditioning) systems.
2. Timing Belts-a belt with teeth on the inner side that fit teeth on the pulley. Timing belts are used in applications that require precise synchronization of shafts or where high torque transmission is necessary, such as in automotive engines and robotics.
3. Flat Belts-a rectangular cross-section belt used in applications where a wide, flat surface is required for power transmissions like conveyor systems, printing machines, and textile machinery.
4. Serpentine Belts-a flat belt with multiple grooves on one side. They are used in automotive engines to drive various accessories like an alternator, power steering pump, and air conditioning compressor.
5. Round Belts-a circular cross-section belt used in applications that require high flexibility and minimal vibration. They are often used in conveying systems, power transmission in small appliances, and some types of delicate machinery.

Optionally, the looped moving element is a cable.

Optionally, the looped moving element is a strap.

Optionally, the looped moving element is a rope.

Optionally, the looped moving element is a chain.

### III. INDICATORS

The indicator may provide many types of information relating to varied aspects of the health of the moving element. Non-limiting examples include the range of motion of the moving element, detected anomalies in the range of motion of the moving element, the structure of the moving element, defects detected in the moving element, health evaluations, alerts, and maintenance-related information.

Indicators providing information about the motion of the moving element may include but are not limited to:
1) The magnitude of the range of motion of one or more sections of the moving element;
2) The estimated tension in a looped moving element;
3) A rate of change of the range of motion of the moving element over time;
4) The time period for the moving element to move through the entire range of motion;
5) A rate of change of the time period for the moving element to move through the entire range of motion; and
6) A difference between an expected range of motion and the detected range of motion.

Health-related indicators may include data including but not limited to:
1) The health of the moving element;
2) The health of a machine utilizing the moving element;
3) The health of a vehicle utilizing the moving element;
4) The health of a mechanism utilizing the moving element;
5) The health of an associated component; and
6) The health of other sensors in the vicinity of the moving element, such as temperature sensors, vibration sensors and others.

Maintenance-related indicators may include but are not limited to:
1) Maintenance instructions;
2) A time to failure estimation;
3) A failure alert; and
4) Operating instructions in response to a detected failure.

### IV. DETERMINING THE RANGE OF MOTION IN A MOVING ELEMENT

Optionally, the range of motion of the moving element is determined from one or more blurred images of the moving element. The blurred image(s) are captured by at least one optical sensor using an exposure time that is too long to capture a clear image of the moving element when it is in motion. Images with adequate quality for analysis may be captured by standard cameras and there is no need high-performance optical sensors. Examples of determining the range of motion from a blurred image for a looped moving object and for a rotating moving object are presented in more detail below.

Optionally, the exposure time of at least one optical sensor is selected so as to create a motion blur of said moving element within image(s) of the moving element captured by the optical sensor.

In some embodiments the range of motion is determined from a single image. When the cyclic motion of the moving object (e.g. a looped moving object) is fast relative to the exposure time of the optical sensor, enough repetitions will be captured in a single frame so that the entire amplitude of the range of motion may be seen in the blurred trace and analyzed, without needing more than one transverse frame.

Typically, standard optical sensors are too slow to capture a fast-moving object in a sharp, blur-free image. The minimum exposure time for a standard CMOS sensor with 30 frames per second (FPS) is typically 1/300 of a second. However, this is just a theoretical limit. In practice, the minimum required exposure time may be longer to avoid a lack of light.

For example, in embodiments where each frame is captured in 1/100th of a second (approximately 0.01 seconds). Typically, a motion blur of one pixel in the image might still be considered reasonably sharp. Taking the width of a pixel as the maximum linear distance the object can move in one frame. Assuming the width of one pixel in the image is 0.1 millimeters (0.0001 meters):

Maximum Speed (m/s)=0.0001 m/0.01 s≈0.01 m/s.

Therefore, for a 30 fps camera, an object moving faster than approximately 0.01 meters per second (or 10 millimeters per second) is likely to result in noticeable motion blur in the captured images.

Alternately or additionally, the range of motion is determined from multiple images. Optionally, the multiple images are a video sequence of images taken by the same optical sensor at different times (e.g. a two second video sequence containing 50-60 frames).

Alternately or additionally, the range of motion calculated by a statistical analysis of image data of a sequence of images, for example using statistical or clustering techniques such as Principal Component Analysis (PCA).

Optionally, the color and/or brightness and/or blurred appearance of the moving object in image data captured during cyclic motion are analyzed to detect changes in the speed and frequency of the moving object's movement and/or its acceleration or deceleration.

Optionally, the illumination source is at a fixed location relative to moving element 440.

The inventors have found that the number of times the object is captured in a frame changes the color and the blurred appearance of the image. This is because each time the object passes through the frame it adds light to the sensor, making it appear brighter.

Optionally, information about the motion of the moving element (e.g. speed) is extracted from the image data by analyzing image properties (such as color and brightness) and/or the shape of the blurred moving element within the image. The effects of the motion of the moving element on the image properties and the shape of the blurred moving element in the image are described below.

The amount of change in color will depend on the speed of the object, the exposure time of the camera, and the sensitivity of the camera sensor. If the moving object is moving very quickly or the exposure time is very short, the object may appear to be a solid color. However, if the object is moving more slowly or the exposure time is longer, the object may appear to have a gradient of color, with the brightest parts of the object being the parts that have passed through the frame multiple times.

Additionally, when the moving object is moving quickly and passing through the frame multiple times the contour of its blurred shape in the image will vary, depending on the speed and frequency of the moving object's movement.

For example, if an object is moving at a constant speed, the blurred image will be uniform across the moving object. However, if the moving object is accelerating or decelerating, the blur will be more pronounced at the front or back of the moving object, depending on the direction of the acceleration.

If a moving object is moving at a constant rate, the blurred image will be uniform across the object. However, if the rate of object motion is changing, the blur will be more pronounced at the edges of the object, as the object is moving at different speeds at different points in its cycle.

Optionally, the monitoring is performed automatically when the moving element is in motion. Further optionally, the monitoring is automatically stopped when the moving element stops moving.

Optionally, at least one optical sensor does not view the moving element from a perpendicular direction and the image data is processed to compensate for the distortion caused by the angle between the optical sensor and moving object. For example, techniques such as photogrammetry and dimensional analysis use known measurements of objects or reference markers in the image to calculate the size of other objects, as long as there are other elements in the image with known sizes, distance or perspective that may serve as references or scale factors.

### IV.1. Determining the Range of Motion in a Looped Moving Element

According to some embodiments of the invention, the monitoring system evaluates the health of a looped moving element by analyzing the range of motion of the looped moving element in one or more secondary directions of motion.

There are known formulas for calculating the deflection of a looped moving element when it is not in motion, based on the span length and other relevant parameters. However, additional factors come into play when the looped moving object is in motion and rotating, such as the load on the driven pulley, belt tension and centrifugal forces. This complicates the analysis, making it unfeasible to calculate the range of the deflection while the system works.

Embodiments of the invention determine the range of motion of a looped moving element from image data collected for the looped moving element while it is in motion.

One example of a secondary direction of motion is a motion of the looped moving element upwards and/or downwards relative to the surface of the looped moving element during normal operation (also denoted herein the vertical direction of movement). It may be expected that the vertical range of motion is larger when the looped moving element is operating under less tension than when the looped moving element is operating under greater tension. For example, in FIG. 5A the primary direction of motion is a longitudinal motion (left arrow) and the second direction of motion is transverse to the longitudinal motion (vertical arrow).

A second example of a secondary direction of motion is a motion of the looped moving element from side to side on the pulleys during normal operation (also denoted herein the lateral direction of movement). It may be expected that the lateral range of motion is larger when the looped moving element is operating under less tension than when the looped moving element is operating under greater tension. For example, in FIG. 6A the primary direction of motion is a longitudinal motion (left arrow) and the second direction of motion is lateral motion along the pulleys (vertical arrow).

For purposes of explanation, simplified examples of primary and secondary directions of motion of a looped moving element are illustrated in FIGS. 5A and 6A.

Reference is now made to FIGS. 5A-5C, which are simplified exemplary illustrations of a looped moving element viewed from the side at respective points in time. Note that FIGS. 5A-5C do not show an image blur and therefor would not be used to determine the range of motion when the determination is made from a blurred image but may be used with other image analysis techniques. In FIG. 5A the top surface of looped moving element 500 is flat and horizontal (as indicated by dashed line A), which may be considered a normal state. FIGS. 5B-5C illustrate looped moving element 500 with upward and downward motion respectively. In FIG. 5B the maximum height of looped moving element 500 is d1 relative to the expected height (as indicated by dashed line B). In FIG. 5C the minimum distance of looped moving element 500 below the expected height is d2 (as indicated by dashed line C). Thus the maximum range of motion of looped moving element 500 in the vertical direction is d1+d2, FIG. 5D illustrates the contour of the blurred looped moving element created by capturing the image data using a long exposure time while the looped moving element.

Reference is now made to FIGS. 6A-6C, which are simplified exemplary illustrations of a looped moving element viewed from above (i.e. with the optical sensor pointed downwards towards looped moving element 610) at respective points in time. Note that FIGS. 6A-6C do not show an image blur and therefor would not be used to determine the range of motion when the determination is made from a blurred image but may be used with other image analysis techniques.

In FIG. 6A looped moving element 610 is centered on pulleys 620 and 630 (as indicated by dashed line D), which may be considered a normal state. FIGS. 6B-6C illustrate looped moving element 600 with lateral motion across pulleys 620 and 630. In FIG. 6B looped moving element 600 is displaced by d3 relative to the center (as indicated by dashed line E). In FIG. 6C looped moving element 600 is displaced by d4 relative to the center (as indicated by dashed line F).

FIG. 6D shows the contour of the blurred looped moving element in an image. The blurring effect was created by capturing the image data using a long exposure time while the looped moving element. The total range of motion of looped moving element 600 in the lateral direction is d3+d4, see 650 in FIG. 6D.

In some embodiments the invention, the exposure time of at least one optical sensor capturing images of the moving element so that it equals or exceeds the expected time it will take for the moving element to transition over the entire range of motion (e.g. from B to C in FIGS. 5B-5C or from D to E in FIGS. 6B-6C). Further optionally, the processing circuitry controls the exposure time of the optical sensor.

The relatively long exposure time creates a blurred effect at the section of the belt in the field of view of the respective optical sensor, as illustrated in FIGS. 5E and 6D. The portion of the image showing the belt appears as a two-dimensional shape in locations where there is transverse motion of the belt (vertical and/or lateral). Thus an optical sensor capturing images of Section 4 in FIG. 5D will include a shape spanning from B to C and an optical sensor capturing images of Section 5 in FIG. 6C will include a shape spanning from E to F.

FIG. 5E shows a simplified image 540 captured by an optical sensor (not shown) viewing the looped moving element from the side. Due to the relatively long exposure time, the total range of motion over a limited section of the belt (section 4) is visible in the image as 550. The range of motion of the looped moving element may be calculated as the maximum distance between the top and bottom of the blurred portion of the moving element in the image (e.g. 550 of FIG. 5E).

FIG. 6D shows a simplified image 640 captured by an optical sensor (not shown) pointing downwards towards the top surface of the looped moving element. Due to the relatively long exposure time, the total range of motion over a limited section of the belt (section 5) is visible in the image as 650.

Note that 550 and 650 show the range of motion relative to the field of view of the optical sensor, not necessarily in absolute terms (e.g. in mm.). Image processing may be performed on image 540 to compensate for factors such as field of view, viewing angle, distance of the optical sensor from the looped moving element, angle of the optical sensor relative to the looped moving element and other factors.

FIGS. 5A-6D illustrate situations in which the secondary range of motion is relatively simple. For example, FIGS. 5B-5C illustrate a situation in which the lateral motion forms a single arc between the two pulleys. FIGS. 6B-6C illustrate a situation in which the looped moving element moves equally on both pulleys, so that the blurred portion of the image showing this motion is rectangular. However, the moving element's transverse motion may be more complex.

When a looped moving element (such as a belt between two pulleys) is not tensioned properly, it may deflect or move in a transverse motion. This deflection may be seen as a multi-peak wave or a multi-peaked waveform between the two pulleys. The belt may form several peaks as it sags and moves in a non-linear path due to the lack of tension. The shape of the wave, its length (distance between the peaks), amplitude (height of the peaks), and its position may depend on factors such as:
a. The speed of movement and tension of the belt;
b. The distance between the pulses;
c. The coefficient of friction between the belt and the pulleys;
d. The alignment of the pulleys;
e. The wear and tear of the belt; and
f. The temperature of the environment.

To illustrate, reference is now made to FIG. 6E which is a simplified exemplary illustration of a looped moving element with a multi-arced motion between the two pulleys. In FIG. 6E the contour of the vertical motion has a triple-peaked wavelike shape, as illustrated by the three substantially ovoid sections 530.1-530.3. Therefore imaging too narrow a section of the moving element (e.g. section 6) may not capture the entire range of motion.

More complex situations may arise. For example, the wavelike shape may change over time which will change the location(s) that undergo the entire range of motion.

Optionally, the minimum width of the image data used to determine the range of motion equals or exceeds the distance between two peaks (e.g. between two maximum levels). Thus the image data may be sufficient to determine the entire range of motion of the moving element. Note that the image section must not necessarily be aligned with the peaks (as in Section 7) but may be offset (as in Section 8).

Optionally, the image data includes multiple images captured by different optical sensors imaging substantially adjacent sections of the moving element, which together span the desired distance along the moving element.

### IV.2. Determining the Range of Motion in a Rotating Moving Element

According to some embodiments the moving element is a rotating moving element, such as a shaft, a rotor, propeller, fan blades, impeller, turbine blade and/or turbo blade.

Optionally, the monitoring is performed automatically when the moving element is in motion. Further optionally, the monitoring is automatically stopped when the moving element stops moving.

Optionally, the range of motion is determined from a single image.

Alternately or additionally, the range of motion is determined from multiple images, such as a video sequence of images (e.g. a two second video sequence containing 50-60 frames).

Optionally, the monitoring system evaluates the health of a rotating moving element by analyzing changes in the range of motion of sections of the rotating moving element in images taken with relatively long exposure times relative to sharper image(s) and/or relative to images taken while the rotating moving element is not in motion.

Optionally, color changes are used to detect changes in speed, frequency, etc. of the rotation of the moving element (e.g. rotation speed of a propeller or turbine blade).

Alternately or additionally, the irregularities are detected by a statistical analysis of image data of a sequence of images, for example using statistical and clustering techniques such as Principal Component Analysis (PCA).

Reference is now made to FIGS. 6F-6H, which are simplified schematic illustrations of three examples of a rotating moving element. The right side of each figure shows the rotating moving element when it is stationary. The left side of each figure shows the contour of the rotating moving element created by the blurring effect of capturing the image data of the rotating moving element with a long exposure time while it is in motion.

FIG. 6F is a simplified illustration of a shaft 6000 attached at one to element 6001 (e.g. a rotating plate). Shaft 6000 has no curvature or bends. Because the shaft is straight, an image of the shaft rotating on its own axis taken with a long exposure time (left side of the figure) is substantially the same as an image of the rotating shaft taken with a short exposure time or when the shaft is stationary (right side of the figure).

However, if the shaft has a bump or other irregularity the images of the shaft taken with a long exposure time (e.g. at least equal to the time it takes for an entire rotation of the shaft) are different than images captured when the shaft is static (or taken with a short exposure time), as illustrated in FIGS. 6G-6H.

FIG. 6G is a simplified illustration of a shaft 6001a with a curvature at end 6002a. An image with a long exposure time taken of shaft 6001a during rotation (left side of FIG. 6G), has a different shape 6002b at the area of curvature, as indicated by the range of motion that is larger than the height of the shaft at 6001a (i.e. a larger difference between the top and bottom of the curved section). The portion of the shaft which is not curved remains the same size and shape in both images.

FIG. 6H is a simplified illustration of a shaft 6011a with a curvature in the middle 6012a. An image with a long exposure time taken of shaft 6011a during rotation (left side of FIG. 6H) has a different shape 6012b at the area of curvature, as indicated by the range of motion that is larger than the height of the shaft at 6011a (i.e. a larger difference between the top and bottom of the irregular section). The portion of the shaft which is not curved remains the same size and shape in both images.

According to some embodiments, at least one optical sensor is configured to capture one or more images of a rotating element while it is rotating. The images are captured by the optical sensor(s) with a shutter exposure time that is longer than the shutter exposure time that is required to capture a sharp image, or with a frame per second (FPS) rate which is lower than the FPS rate that is required to capture a sharp image (for example a standard 30 or 60 or 120 FPS optical sensor). This creates a blurred effect at locations having irregularities.

Optionally, the processing circuitry is configured to detect an undesired irregularity in a rotating moving element by analyzing changes in the size and/or shape of one or more sections of the shaft within the images. Changes in the size and/or shape may be indicative of a fault or failure in the rotating moving element or in an associated element. For example, a fault may be detected if the height increase in a section of the shaft is larger than a predefined threshold. The indicator may include information that a fault/failure/trend towards failure/etc. has been detected and optionally further data (such as the size of the irregularity). Some irregularities may be caused by the normal shape of the rotating moving element, however these may be disregarded when evaluating the health of the moving object if desired.

### V. HEALTH EVALUATION ANALYSIS

The range of motion and/or changes in the range of motion over time provide information about the health of the moving element and/or associated elements. Examples include but are not limited to:

1) Tension—A greater range of motion may reflect that a looped moving element is operating under less tension and a smaller range of motion may reflect that the looped moving element is operating under more tension.

2) Material health—The range of motion may be affected by the health of the materials forming the moving element. A deterioration in the materials (e.g. a tear) may lead to a reduction or increase in the range of motion.

3) Associated elements—The range of motion may be affected by the operation of associated elements. For example, changes in the relative location of pulleys may lead to changes in the range of motion of the moving element looped around them.

Optionally, evaluating of the health of the moving element is threshold-based. Thresholds and/or ranges may be defined for parameters such as the magnitude of the range of motion, the rate of change of the range of motion and other parameters related to the range of motion. For example, a maximum threshold may be defined for the range of motion. If that threshold is exceeded, the analysis indicates a fault in the moving element.

Optionally, other data is used in the analysis, such as information provided by other sensors (e.g. vibration sensors or temperature sensors), information about previous failures, device specifications, etc. This additional information may reduce false positives (e.g., alerts of failures when there is no failure).

Optionally, evaluating of the health of the moving element includes predicting the future health of the moving element by performing trend analysis on changes in the range of motion over time. Trend analysis may be performed using any suitable technique known in the art. Examples of trend evaluation techniques include moving average, exponential smoothing, seasonal decomposition, autoregressive integrate moving average (ARIMA), long short-term memory (LSTM) networks and support vector regression (SVR).

Optionally, evaluating of the health of the moving element is based on the shape and/or in changes in the shape of the moving element, as seen in the image data. For example, a change in the height of a pulley belt that is not present in all images but rather shows up synchronously relative to the longitudinal motion of the belt indicates that a protuberance has developed at that location. When the size of the protuberance exceeds permitted dimension, the protuberance may be considered a fault.

The results of the image analysis may be correlated with information from one or more other sensors or external sources. Non-limiting examples include:
1) Motion sensor (e.g. accelerometer, gyroscope, magnetometer, magnetic compass, vibration or tilt sensor);
2) Temperature sensor;
4) Control system information (e.g. times of operation of the moving element, load, time since last replacement of the moving element, etc.).

In one example, a motion sensor gives information about times that the moving element is moving, and images from those times may be used to evaluate the health of the moving element.

In a second example, a temperature sensor provides information about the temperature of the moving element. The health of the moving element may be considered to deteriorate more quickly when it is operating at a high temperature.

In a third example, health of the moving element may be considered to decline over time since last replacement.

### VI. GENERATING AND OUTPUTTING AN INDICATOR

An indicator is generated based on the results of the analysis of the range of motion. The indicator may be output to external elements as described herein and/or used by the processing circuitry to control the moving element, according to any of the embodiments described herein. The indicator may be formatted in any suitable format known in the art.

The data included in the indicator may be adapted to the element to which it is being sent. For example, an indicator provided to an external controller may be a general health rating for the moving element (e.g. on a numerical scale) and an alert when a failure is detected. In a second example, an indicator displayed to a user may include more detailed information about the range of motion in one or more directions, trend analysis, fault and failure alerts, etc. and/or maintenance instructions. In another example, an indicator to a predictive maintenance system may include only the current range of motion in one or more directions, for further analysis by the predictive maintenance system.

Optionally, the indicator includes the images and/or videos of the moving element, further optionally at slow motion in order to enable a technician to evaluate.

Optionally, the indicator includes information received from other sources, such as external sensors, information from a control system, etc.

The time(s) at which the analysis and the generation of the indicator are performed may be tailored to the needs of a particular system, machine, aircraft, etc. Examples of when the analysis and indicator output may be performed include but are not limited to:
1) Ongoing;
2) Periodically.
3) Only during operation;
4) Both during operation and during idle time periods.
5) When an indication of a problem is received, for example from other sensors in the system.

Optionally the analysis is performed more frequently when certain conditions appear (e.g. high temperature).

Optionally, the indicators are used by a control system and/or preventive maintenance system, which decide whether further actions should be taken (for example decisions about the operation and/or maintenance of the moving element).

### 1. Data Structure

Optionally, the indicator is retrieved from a data structure indexed by at least one parameter determined from the analysis of the range of motion, and optionally additional information.

Parameters which may be used to retrieve the indicator from the data structure include but are not limited to:
1) The range of motion of one or more sections of the moving element;
2) The rate of change of the range of the motion of the moving element over one or more sections of the moving element;
3) Trend(s) in the range of motion and/or other health-related parameters of the moving element over time. The trends may be evaluated based on any technique known in the art, such as seasonal decomposition of time series (STL).
4) The tension on the moving element calculated based, at least in part, on the range of motion of one or more sections of the moving element;
5) Data obtained from other sensors (e.g. motion sensors, temperature sensors, optical sensors imaging other elements, etc.).
6) Data provided by element(s) associated with moving element (e.g. an external system controller).
7) Information about other features of the moving element, such as identified tears or shape irregularities.

In a simplified example, the health analysis is based on only on the range of motion of the moving element, and the health evaluation and consequently the selection of the indicator are based on comparison to two thresholds.

For example, in a looped moving element:
1) Range of motion<1 mm.—Looped moving element is operating within desired range. Indicator provides information that looped moving element is in good health. No action is needed by system controller and/or user.
2) Range of motion within 1-3 mm.—Looped moving element is operating at lower than desired tension but within accepted tolerance. Indicator provides information that a fault is detected. No immediate action is needed by system controller and/or user. A predictive maintenance system may update the time until maintenance to a shorter period. The indicator may also include information about trends in the range of motion of the looped moving element in a recent time period.
3) Range of motion>3 mm.—Looped moving element has failed. Indicator includes a failure alert that immediate action is needed by system controller and/or user. The indicator may also include the current range of motion of the looped moving element.

Reference is now made to Table 1, which is a simplified example of a data structure that may be used to select an indicator for output.

TABLE 1

| Range of | Health | | |
|---|---|---|---|
| Motion (mm) | Evaluation | Indicator | Action Required |
| <1 | Good Health | Green | No action needed. |
| 1-3 | Lower | Yellow | No immediate action needed. |
| | Tension | | Predictive maintenance may |
| | | | update maintenance schedule. |
| >3 | Failed | Red | Immediate action needed. |

### 2. Model-Based Evaluation

Alternately or additionally, evaluation of the health of the moving element and/or selecting the indicator to be output is based on a model. The model may be developed by any means known in the art.

In some embodiments, the model used for evaluation the health of the moving element and/or selecting the indicator to be output is a machine learning model trained with a training set by supervised learning algorithm or by a non-supervised learning algorithm. Optionally, the model is a neural network.

Optionally, the training set includes one or more of:
1) Images collected of the moving element or a similar moving element during periods of operation;
2) Images collected of the moving element or a similar moving element during periods of non-usage.
3) Image(s) of associated element, possibly provided by other optical sensors.
4) Non-image data associated with some or all of the images in the training set. For example the non-image data may include environmental and operational conditions when the image was captured.

Optionally, some or all of the images are tagged with associated information, such as the range of motion when the image data was captured, whether a fault or failure had been detected when the image data was captured, the revolution rate of a rotating moving object, the longitudinal speed of a looped moving element, etc.

Optionally, the model is trained prior to actual use of the moving element (e.g. during a preliminary training period).

Optionally, the model is trained during a preliminary training period on image data of similar moving elements and/or on moving elements in similar systems.

Optionally, the model is periodically retrained based on image(s) and or other data collected over time.

### VII. IMAGE DATA OF OTHER COMPONENTS

Optionally, the monitoring system also inputs data of other components in the mechanism and/or associated element(s) (e.g. machine/vehicle/aircraft/etc.) and performs additional evaluation, optionally as described in PCT Publ. WO2022162663, U.S. Provisional Pat. Appl. No. 63/394,150, U.S. Provisional Pat. Appl. No. 63/521,140 and corresponding PCT application filed on same date of the present PCT application, and U.S. Provisional Pat. Appl. No. 63/394,138 and corresponding PCT application filed on same date of the present PCT application, which are incorporated by reference in their entireties into the specification. The images may be provided by the optical sensors imaging the moving element and/or by other optical sensors.

The additional evaluation may identify defects and/or faults not necessarily related directly to the motion of the moving element, such as corrosion, cracks, structural damage, etc. The additional analysis may be combined with embodiments of the analysis of the motion of the moving element described herein to provide a more complete heath analysis of a mechanism and components thereof.

### VIII. METHOD OF MONITORING A MOVING ELEMENT

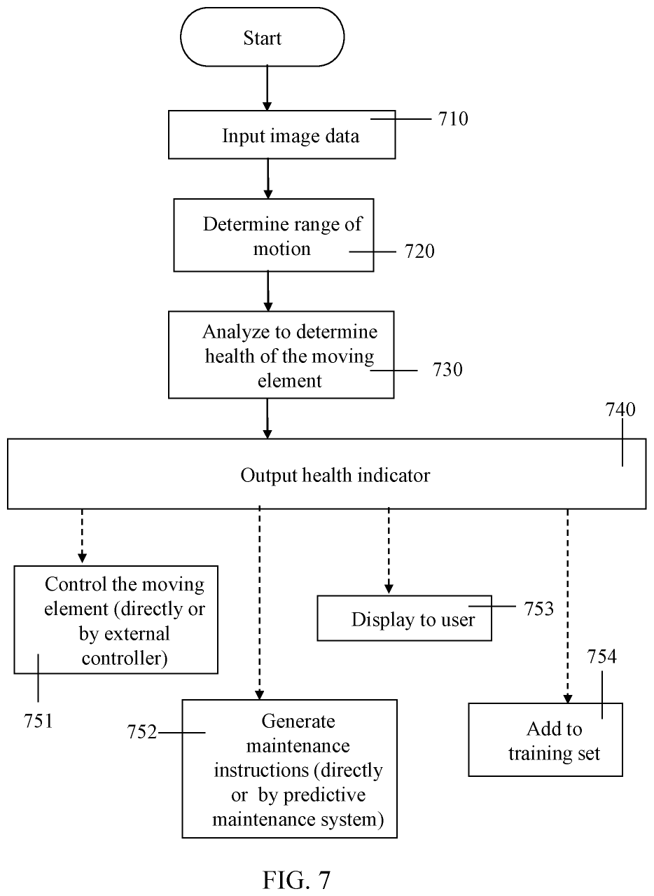

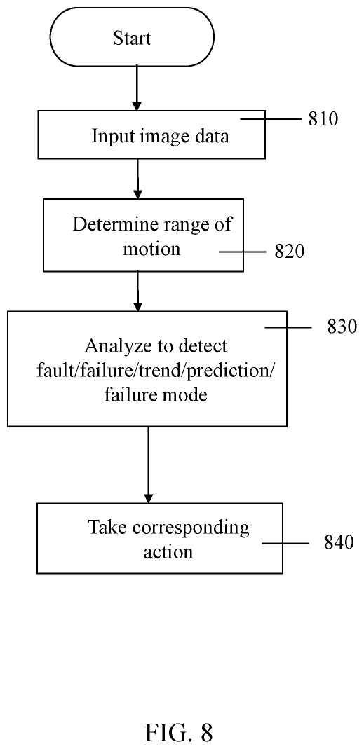

Reference is now made to FIGS. 7-8, which are simplified flowcharts of methods for monitoring a moving element, according to respective embodiments of the invention. Optional embodiments of inputting image data, determining range of motion of the moving element, analysis of the range of motion and generating and outputting the indicator are described above.

Referring to FIG. 7, in 710 image data of at least one section of a moving element is input from at least one optical sensor. In 720, the range of motion in a secondary direction is determined. In 730, the range of motion is analyzed to determine the health of the moving element. In 740 an indicator of the health of the moving element is output.

Optionally, the range of motion is determined by calculating the maximal amplitude of opposite sides of a contour of the moving element in an image captured with an exposure time exceeding the expected time for the moving element to transition over the entire range of motion. As explained above, the relatively long exposure time causes the moving element to appear as a blurred contour.

Optionally, the method further includes controlling the optical sensor to capture an image of the moving object with an exposure time exceeding the expected time for the moving element to traverse the entire range of motion.

Optionally, in 751 the method further includes controlling the moving element directly and/or by an external controller.

Optionally, in 752 the method further includes generating maintenance instructions directly and/or by a predictive maintenance system.

Optionally, in 753 the method further includes displaying information to the user on a user interface. The displayed information includes some or all of the results of the analysis of the range of motion of the moving element. Further optionally, the displayed information includes an alert that the moving element and/or associated element require attention (e.g. shutoff).

Optionally, in 754 the method further includes outputting the indicator and/or image data to a machine learning system. The machine learning system may use the information provided to train and/or retrain a model of the moving element.

Referring to FIG. 8, in 810 image data of at least one section of a moving element is input from at least one optical sensor. In 820, the range of motion in a transverse direction is determined. In 830, the range of motion is analyzed to detect one or more aspects relating to the health of the moving element.

Optionally, an aspect is a fault detected in the moving element.

Optionally, an aspect is a failure detected in the moving element.

Optionally, an aspect is a trend in changes in the range of motion of the moving element (or example, if the range of motion is increasing slowly or rapidly).

Optionally, an aspect is a prediction of a time to failure of the moving element or an associated element.

Optionally, an aspect is an identified failure mode. Examples of failure modes include but are not limited to:
1. Fracture or Breakage: The moving element may experience fractures or breaks, resulting in complete failure. This may occur due to excessive tension, overloading, or material fatigue.
2. Cord or Ply Separation: In a looped moving element with multiple layers or plies, the layers may separate from each other, leading to reduced strength and effectiveness.
3. Excessive Wear: Continuous rubbing against pulleys or other components may cause significant wear on the looped moving element's surface, leading to thinning and reduced performance.
4. Glazing or Hardening: The moving element's surface may become glazed or hardened due to excessive heat or improper tension, reducing its grip and efficiency.
5. Cracking or Aging: Over time, the moving element's material may age or degrade, leading to cracks and reduced flexibility.
6. Edge Wear: The sides of a looped moving element may experience wear, leading to a reduction in width and decreased contact area with the pulleys.
7. Material Deformation: The moving element material may deform under high loads or elevated temperatures, affecting its shape and functionality.
8. Chemical Damage: Exposure to certain chemicals or environmental elements may deteriorate the moving element material, causing it to weaken and fail.
9. Improper Tension: Under-tensioning or over-tensioning a looped moving element may lead to slippage, excessive wear, and premature failure.
10. Foreign Object Damage: Foreign objects, such as debris or contaminants, may get lodged in the moving element, causing abrasion or punctures.
11. Misalignment: Incorrect alignment of a looped moving element with the pulleys may cause uneven stress distribution and accelerated wear.
12. Improper Installation: Incorrect installation techniques, such as using mismatched moving elements or pulleys, may lead to premature failure.

Optionally, an aspect is a trend of a failure mode.

Optionally, an aspect is determining whether a specified failure mode is detected in the moving element.

In 840 an action is taken based on the analysis of the health of the moving element.

Optionally, the action is controlling the moving element and/or associated elements.

Optionally, the action is outputting an indicator of the health of the moving element.

Optionally, the action is outputting an alert of a failure in the moving element.

Optionally, the action is outputting an alert of an expected failure in the moving element.

Optionally, the action is obtaining operating and/or maintenance instructions appropriate for a moving element with the health aspects determined in 830. Further optionally, the operating and/or maintenance instructions are provided to a user.

Optionally, the secondary direction of motion is perpendicular to the primary direction of motion, for example as illustrated in FIG. 5A.

Optionally, the method further includes controlling an operation of the moving element based on the health of the moving element, so as to prevent operation of the moving element during failure.

Optionally, the indicator is output to a controller which controls operations of the moving element based on the health of the moving element, so as to prevent operation of the moving element during failure.

Optionally, the indicator is output to a preventive maintenance system which provides maintenance instructions based on the indicator. Following the maintenance instructions may prevent a fault from developing into a failure.

Optionally, the method further includes displaying the indicator on a user interface so as to alert a user of the health of the moving element.

Optionally, the indicator includes one or more of:
maintenance instructions;
a time to failure estimation;
a failure alert; and
operating instructions in response to a detected failure.

Optionally, a larger range of motion is evaluated as indicative of a lower tension of the moving element relative to a tension at a smaller range of motion.

Optionally, the analysis includes evaluating the health of the moving element by comparing the magnitude of the range of motion to at least one threshold.

Optionally, the moving element is a looped moving element and calculating the maximal amplitude includes calculating the distance between opposite sides of the contour of the blurred looped moving element viewable in the image, at the location having a maximum difference between the sides.

Optionally, the range of motion is determined based on a statistical analysis of a sequence of image frames.

Optionally, the image data includes a video sequence of images.

Optionally, the method further includes evaluating the health of the moving element based on a change of the magnitude of the range of motion over time.

Optionally, the method further includes evaluating the health of the moving element based on a shape of the at least one section.

Optionally, the method further includes evaluating the health of the moving element based on changes in a shape of the moving element in multiple sections of the moving element.

Optionally, the image data includes images provided by multiple optical sensors, each of the optical sensors capturing images of a respective section of the moving element. Alternately, the image data is provided by a single optical sensor at a fixed location relative to the moving element.

Optionally, at least one imaged section of the moving element shows at least 1%, 5%, 10%, 25% or 50% of the length of the moving element. Further optionally, at least one of the sections is between 1%-10%, between 10%-20% or between 1%-50% of the total length of the moving element.

Optionally, the moving element is a looped moving element. Further optionally the looped moving element is one of:
a pulley belt;
a cable;
a strap;
a rope; and
a chain.

Optionally, the looped moving element is looped over at least two pulleys.

Alternately, the moving element is a rotating moving element.

Optionally, the indicator is retrieved from a data structure indexed by at least one parameter determinable from the range of motion, and optionally other parameters.

Optionally, the analysis is based on a machine learning model trained using a training set of images collected during operation of at least one of the moving element and a similar moving element.

Optionally, the machine learning model is a neural network.

Optionally, the machine learning model is trained using a supervised learning algorithm or an unsupervised learning algorithm.

Optionally, the analysis includes predicting a future health of the moving element by performing trend analysis on changes in the range of motion over time.

### IX. EXEMPLARY EMBODIMENTS

According to some embodiments of the invention, there is provided an exemplary system for monitoring condition and/or integrity of operation of a moving and/or rotating element (denoted a moving element for the purpose of this example).

Optionally the moving element is a looped moving element with a primary longitudinal direction of motion. Alternately, the moving element is a rotating moving element with a primary rotational direction of motion.

The system includes at least one optical sensor and a processor. The at least one optical sensor is configured to be fixed on, in vicinity to, and/or in sight with the moving element and is configured to capture a plurality of images of the moving element while in motion. The processor is executable to receive the captured plurality of images from the at least one optical sensor, calculate a maximal amplitude of a secondary motion of the moving element along an axis which is perpendicular to the motion axis and or axial and radial motion of the moving element and/or combination thereof, and if the maximal amplitude of the secondary motion and/or displacement of the moving element is above a predefined threshold, the processor is executable to output a signal indicative of a fault in the moving element or associated with the moving element.

Optionally, the moving element is secured at least at one end thereof to an element stationary relative to the movement of the moving element.

Further optionally, the moving element is a looped moving element, and the element stationary relative to the movement of the looped moving element is a pulley.

In one example, the looped moving element is a pulley belt and the stationary element is the pulley it is looped around. The connection permits the longitudinal motion of the pulley belt.

Alternately, the moving element is a rotating moving element. The stationary element depends on the type of rotating moving element.

In a first example, the moving element is a rotor which rotates around an axis and the stationary element is a stator which is static relative to the frame of the machine it is a component of.

In a second example, the moving element is a rotating rod or shaft and the stationary element is a rotating plate which is attached to the end of the rod and causes it to rotate.

In a third example, the moving element is a rotary shaft that rotates around its axis and the stationary elements are the bearings.

In a fourth example, the moving element is a turbine rotor and the stationary element is the turbine casing.

In a fifth example, the moving element is an impeller and the stationary element is the turbo housing.

According to some embodiments, the system may be for example a system for monitoring tension and/or tightness of a looped moving element (e.g. belt, chain or band) which is connected between two elements, such as a timing belt which is connected between two pulleys. The monitoring takes place while the looped moving element is in motion and in real-time.

According to some embodiments, the system may be for example a system for monitoring distortions in a rotating moving element (e.g. shaft or turbine blades) which is connected between two elements, such as a timing belt which is connected between two pulleys. The monitoring takes place while the rotating moving element is in motion and in real-time.

The system may be configured to provide an indication of the integrity of the moving element. Alternatively, or additionally, the system may be configured to provide an indication of potential failure in the moving element or in a function thereof.

According to some embodiments, the system may be configured to receive signals, such as images and/or image data, from the at least one optical sensor positioned on or in vicinity of the moving element. According to some embodiments, the system may be configured to identify at least one change in the received signals. According to some embodiments, for an identified change in the received signals, the system may be configured to apply the at least one identified change to an algorithm configured to analyze the identified change in the received signals and to classify whether the identified change in the received signals is associated with a mode of failure of the moving element, thereby labeling the identified change as a fault, based, at least in part, on obtained data associated with a failure mode of the moving element. According to some embodiments, for an identified change that is classified as being associated with a mode of failure, the system may output a signal indicative of the identified change associated with the mode of failure.

According to some embodiments, the system may be configured to generate at least one model of a trend in the identified fault, wherein the trend may include a rate of change in the fault.

According to some embodiments, the system may be configured to prevent failure of the moving element by identifying a fault in real-time and monitoring the changes of the fault in real-time.

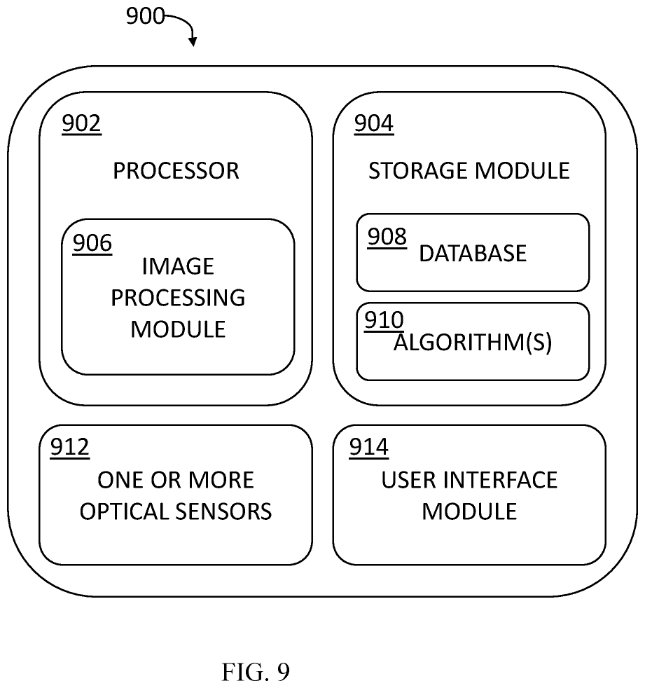

Reference is made to FIG. 9, which is a schematic illustration of a system for monitoring potential failure in a moving element, optionally secured at least at one end thereof to an element stationary with regards to the movement and/or rotation of the element, in accordance with some exemplary embodiments of the present invention.

According to some embodiments, the system 900 for monitoring potential failure in an element may include one or more optical sensors 912 configured to be fixed on or in vicinity of the moving element. According to some embodiments, the system 900 may be configured to monitor the moving element in real-time. According to some embodiments, the system 900 may include at least one processor 902 in communication with the one or more optical sensors 912. According to some embodiments, the processor 902 may be configured to receive signals (e.g. image data, images, other data, etc.) from the one or more optical sensors 912. According to some embodiments, the processor 902 may include an embedded processor, a cloud computing system, or any combination thereof. According to some embodiments, the processor 902 may be configured to process the signals received from the one or more optical sensors 912 (also referred to herein as the received signals or the received data). According to some embodiments, the processor 902 may include an image processing module 906 configured to process the signals received from the one or more optical sensors 912.

According to some embodiments, the one or more optical sensors 912 may be configured to detect light reflected from the surface of the moving element. This may be advantageous since surfaces with different textures reflect light differently. For example, a matt surface may be less reflective and may scatter (diffuse) light equally in all directions, in comparison with a polished surface, that would reflect more light than an unpolished one, because it has an even surface and reflects most of the light rays parallel to each other. A polished surface, being smooth and lustrous, may absorb a very little amount of light and may reflect more light, thereby the image detected from light that reflects from a polished surface may be clearer than an image detected from light reflected off an unpolished surface. Thus, the surface texture of a fracture, cut or any other surface defect may be different from the un-damaged surface surrounding it (or in other words, the original base-line surface), therefore the different light reflections from the surfaces allow the detection of small defects. Moreover, by changing the wavelengths, intensity, and/or directions of the light, this phenomenon can be intensified. According to some embodiments, and as described in greater detail elsewhere herein, the system may include one or more light sources (also referred to herein as illumination source) configured to illuminate the moving element.

According to some embodiments, changing the direction of the light may include moving the light sources. According to some embodiments, changing the direction of the light may include maintaining the position of two or more light sources fixed, while powering (or operating) the light sources at different times, thereby changing the direction of the light that illuminates the moving element. According to some embodiments, and as described in greater detail elsewhere herein, the system may include one or more light sources positioned such that operation thereof illuminates the moving element. According to some embodiments, the system may include a plurality of light sources, wherein each light source is positioned at a different location in relation to the moving element.

According to some embodiments, the wavelengths, intensity and/or directions of the one or more light sources may be controlled by the processor. According to some embodiments, changing the wavelengths, intensity and/or directions of the one or more light sources thereby enables the detection of surface defects on the surface of the moving element. According to some embodiments, the one or more optical sensors 912 may enable the detection, by analyzing the reflected light, of microscopic dents and/or defects, such as, for example, 2-3 tenths of a millimeter, which may be invisible to the naked eye.

According to some embodiments, the one or more optical sensors 912 may include a camera. According to some embodiments, the one or more optical sensors 912 may include an electro-optical sensor. According to some embodiments, the one or more optical sensors 912 may include any one or more of a charge-coupled devices (CCD) and a complementary metal-oxide-semiconductor (CMOS) sensor (or an active-pixel sensor), or any combination thereof. According to some embodiments, the one or more optical sensors 912 may include any one or more of a point sensor, a distributed sensor, an extrinsic sensor, an intrinsic sensor, a through beam sensor, a diffuse reflective sensor, a retro-reflective sensor, or any combination thereof.

According to some embodiments, the one or more optical sensors may include one or more lenses and/or a fiber optic sensor. According to some embodiments, the one or more optical sensor may include a software correction matrix configured to generate an image from the received data. According to some embodiments, the one or more optical sensors may include a focus sensor configured to enable the optical sensor to detect changes in the obtained data. According to some embodiments, the focus sensor may be configured to enable the optical sensor to detect changes in one or more pixels of the obtained signals.

According to some embodiments, the system 900 may include one or more user interface modules 914 in communication with the processor 902. According to some embodiments, the user interface module 914 may be configured for receiving data from a user, wherein the data is associated with any one or more of the moving element, the type of moving element, the type of in which the moving element is used, one or more environmental parameters, one or more modes of failure of the moving element, or any combination thereof. According to some embodiments, the user interface module 914 may include any one or more of a keyboard, a display, a touchscreen, a mouse, one or more buttons, or any combination thereof. According to some embodiments, the user interface 914 may include a configuration file which may be generated automatically and/or manually by a user. According to some embodiments, the configuration file may be configured to identify the at least one segment. According to some embodiments, the configuration file may be configured to enable a user to mark and/or select the at least one segment.

According to some embodiments, the system 900 may include a storage module 904 configured to store data and/or instructions (e.g. code) for the processor 902 to execute. According to some embodiments, the storage module 904 may be in communication (or operable communication) with the processor 902. According to some embodiments, the storage module 904 may include a database 908 configured to store data associated with any one or more of the system 900, the moving element, user inputted data, one or more training sets (or data sets used for training one or more of the algorithms), or any combination thereof. According to some embodiments, the storage module 904 may include one or more algorithms 910 (optionally embodied as computer code) stored thereon and configured to be executed by the processor 902. According to some embodiments, the one or more algorithms 910 may be configured to analyze and/or classify the received signals, as described in greater detail elsewhere herein. According to some embodiments, and as described in greater detail elsewhere herein, the one or more algorithms 910 may include one or more preprocessing techniques for preprocessing the received signals.

According to some embodiments, the one or more algorithms 910 may include a change detection algorithm configured to identify a change in the received signals. According to some embodiments, the one or more algorithms 910 and/or the change detection algorithm may be configured to receive signals from the one or more optical sensors 912, obtain data associated with characteristics of at least one mode of failure of the moving element, and/or identify at least one change in the received signals.

According to some embodiments, the one or more algorithms 910 may include a classification algorithm configured to classify the identified change. According to some embodiments, the classification algorithm may be configured to classify the identified change as a fault. According to some embodiments, the classification algorithm may be configured to classify the identified change as a normal performance (or motion) of the moving element.

According to some embodiments, the one or more algorithms 910 may be configured to analyze the fault (or the identified change classified as a fault). According to some embodiments, the one or more algorithms 910 may be configured to output a signal (or alarm) indicative of the identified change being associated with the mode of failure.

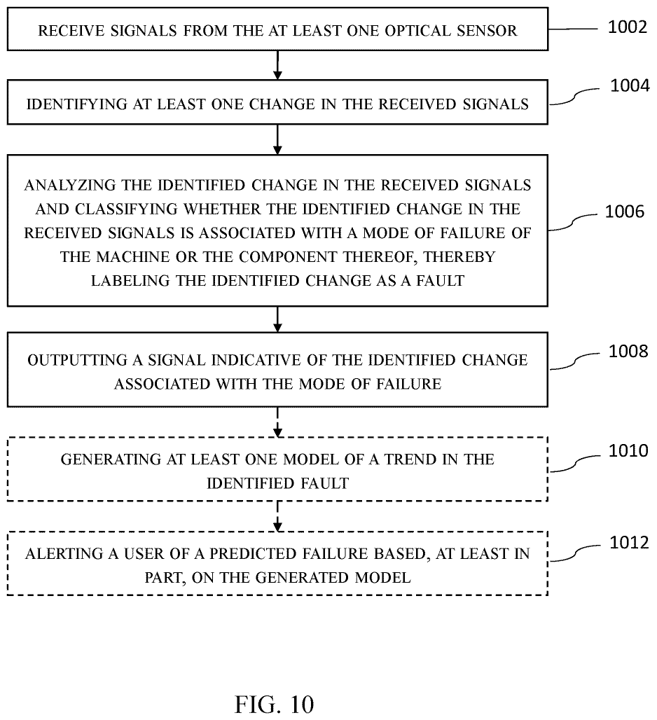

According to some embodiments, the one or more algorithms 910 may be configured to execute, via the processor 902, the method for monitoring potential failure in a moving element, such as the method depicted in FIG. 10.

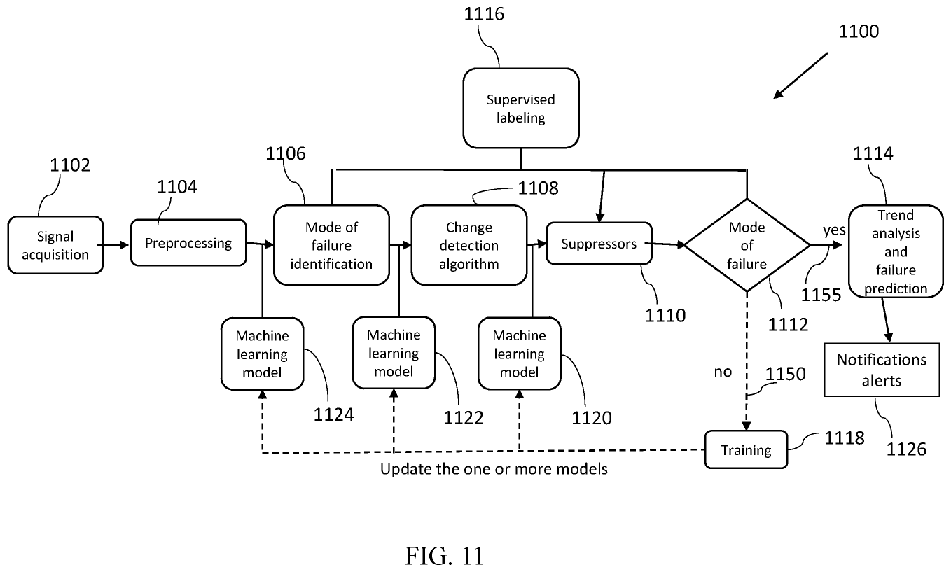

Reference is made to FIG. 10, which is a simplified flowchart of a computer implemented method for monitoring potential failure in a moving element, optionally secured at least at one end thereof to an element stationary with regards to the movement and/or rotation of the moving element, in accordance with some exemplary embodiments of the present invention, and to FIG. 11, which is a simplified schematic block diagram of a method for monitoring potential failure in a moving element, optionally secured at least at one end thereof to an element stationary with regards to the movement and/or rotation of the moving element, in accordance with some exemplary embodiments of the present invention. According to some embodiments, the method 1000 of FIG. 10 may include one or more steps of the block diagram 1100 of FIG. 11.

According to some embodiments, at step 1002, the method may include receiving signals from the at least one optical sensor. According to some embodiments, at step 1004, the method may include identifying at least one change in the received signals. According to some embodiments, at step 1006, the method may include analyzing the identified change in the received signals and classifying whether the identified change in the received signals is associated with a mode of failure of the moving element, thereby labeling the identified change as a fault. According to some embodiments, at step 1008, the method may include outputting a signal indicative of the identified change associated with the mode of failure. According to some embodiments, at step 1010, the method may include generating at least one model of a trend in the identified fault. According to some embodiments, at step 1012, the method may include alerting a user of a predicted failure based, at least in part, on the generated model.

According to some embodiments, such as depicted in FIG. 11, the method may include signal acquisition 1102, or in other words, receiving one or more signals. According to some embodiments, the method may include receiving one or more signals from at least one optical sensor fixed on or in vicinity of the moving element, such as, for example, one or more sensors 912 of system 900. According to some embodiments, the one or more signals may include one or more images. According to some embodiments, the one or more signals may include one or more portions of an image. According to some embodiments, the one or more signals may include a set of images, such as a packet of images. According to some embodiments, the one or more signals may include one or more videos.

According to some embodiments, the method may include preprocessing (1104) the one or more signals. According to some embodiments, the preprocessing may include converting the one or more signals into electronic signals (e.g., from optical signals to electrical signals). According to some embodiments, the preprocessing may include generating one or more images, the one or more sets of images, and/or one or more videos, from the one or more signals. According to some embodiments, the preprocessing may include dividing the one or more images, one or more portions of the one or more images, one or more sets of images, and/or one or more videos, into a plurality of tiles. According to some embodiments, the preprocessing may include applying one or more filters to the one or more images, one or more portions of the one or more images, one or more sets of images, one or more videos, and/or a plurality of tiles. According to some embodiments, the one or more filters may include one or more noise reduction filters.

According to some embodiments, the method may include putting together (or stitching) a plurality of signals obtained from two or more optical sensors. According to some embodiments, the method may include stitching a plurality of signals in real-time.

According to some embodiments, the method may include identifying at least one segment within any one or more of the received signals, one or more images, one or more portions of the one or more images, one or more sets of images, and/or one or more videos. According to some embodiments, the method may include monitoring the (identified) at least one segment. According to some embodiments, the at least one change in the signals is a change within the at least one segment. According to some embodiments, the at least one change in the one or more images, one or more portions of the one or more images, one or more sets of images, and/or one or more videos, is a change within the at least one segment.

According to some embodiments, the user may mark a segment to be monitored onto an image and/or a portion of an image and/or at least a portion of a video. According to some embodiments, the user may input a location to be monitored. According to some embodiments, the algorithm may be configured to identify at least one segment within the location that the user inputted.

According to some embodiments, the method may include applying the one or more signals, the one or more images, the one or more portions of the one or more images, the one or more sets of images, and/or the one or more videos, to a change detection algorithm 1108 (such as, for example, one or more algorithms 910 of system 900) configured to detect a change therein. According to some embodiments, the change detection algorithm may include one or more machine learning models 1122.

According to some embodiments, the method may include detecting if there is a change in the shape of the at least one segment, size of the at least one segment, rate of occurrence of the at least one segment in the received signals, or any combination thereof. According to some embodiments, the method may include detecting if there is a change in the shape, size, and/or rate of occurrence, of the at least one segment, throughout time. According to some embodiments, the method may include detecting if there is a change in the shape, size, and/or rate of occurrence of the at least one segment, throughout a specified time period, such as, for example, a second, a few seconds, a minute, an hour, a day, a week, a few weeks, or any range therebetween.

According to some embodiments, the at least one segment may include a potential fault that needs to be monitored, such as, for example, a surface defect. According to some embodiments, the at least one segment may include an outline of a byproduct of the moving element, such as, for example, a spark igniting a fire. According to some embodiments, the at least one segment may include the boundaries of a surface defect. According to some embodiments, the at least one segment may include the boundaries of at least one of a perimeter of a puddle, a perimeter of a droplet, a perimeter of a saturated area (or material), or any combination thereof. According to some embodiments, the at least one segment may include the boundaries of a spark.

According to some embodiments, the at least one segment may include the boundaries of a specific element of the moving element. According to some embodiments, the method may include identifying a geometrical shape of the at least one segment as the specific element of the moving element. According to some embodiments, the method (or the identifying of the geometrical shape) may include analyzing any one or more of the total intensity, variance intensity, spackle detection, line segment detection, line segment registration, edge segment curvature estimation, homography estimation, specific object identification, object detection, semantic segmentation, background model, change detection, detection over optical flow, or reflection detection, flame detection, or any combination thereof.

According to some embodiments, the method may include obtaining data associated with characteristics of at least one mode of failure of the moving element, or mode of failure identification 1106. According to some embodiments, data associated with characteristics of at least one mode of failure of the moving element may include a type of mode of failure. According to some embodiments, data associated with characteristics of at least one mode of failure of the moving element may include a location or range of locations of the mode of failure on the moving element and/or a specific type of mode of failure.

According to some embodiments, the mode of failure may include one or more aspects which may fail in the moving element. According to some embodiments, and as described in greater detail herein, the mode of failure may include a critical development of an identified fault. According to some embodiments, the mode of failure may include any one of or more of a change in dimension, a change in position, a change in color, a change in texture, a change in size, a change in appearance, a fracture, a structural damage, a tear, tear size, critical tear size, tear location, tear propagation, a specified pressure applied to the moving element, a change in the movement of one component in relation to another component, defect diameter, cut, warping, inflation, deformation, abrasion, wear, corrosion, oxidation, sparks, smoke, change in color/shade, a change in dimension, a change in position, a change in color, change in size, a change in appearance, or any combination thereof.

According to some embodiments, the method may include obtaining data associated with characteristics of at least one mode of failure of the moving element by receiving user input. According to some embodiments, the method may include obtaining data associated with characteristics of at least one mode of failure of the moving element by analyzing the received signals and detecting at least one segment that is associated with a mode of failure. According to some embodiments, the method may include obtaining data associated with characteristics of at least one mode of failure of the moving element by analyzing the received signals and detecting potential modes of failure. According to some embodiments, the method may include obtaining data associated with characteristics of at least one mode of failure of the moving element by analyzing the received signals and detecting one or more modes of failure which were previously unknown.

According to some embodiments, obtaining data associated with characteristics of at least one mode of failure of the moving element includes receiving inputted data from a user. According to some embodiments, the user may input data associated with the mode of failure of the moving element using the user interface module 914. According to some embodiments, the method may include monitoring the moving element based, at least in part, on the received inputted data from the user. According to some embodiments, the user may input the type of failure mode of the moving element. According to some embodiments, the user may input the type of failure mode associated with a specific identified segment. According to some embodiments, the user may input the location of the failure mode. According to some embodiments, the user may identify one or more of the at least one segments as being in a location likely to fail and/or develop a fault.

According to some embodiments, the method may include automatically obtaining data associated with characteristics of at least one mode of failure of the moving element. According to some embodiments, the method may include obtaining data associated with characteristics of at least one mode of failure of the moving element without user input. According to some embodiments, the method may include analyzing the received signal and automatically retrieving the data from a database, such as, for example, the database 908. According to some embodiments, the one or more algorithms 910 may be configured to identify one or more modes of failure, within the database, which may be associated with the identified segment of the received signals of the moving element. According to some embodiments, the method may include searching the database for possible failure modes of the identified segment. According to some embodiments, the method may include retrieving data, from the database, wherein the data is associated with possible failure modes of the identified segment.

According to some embodiments, the method may include obtaining data associated with characteristics of at least one mode of failure of the moving element by identifying a previously unknown failure mode. According to some embodiments, identifying a previously unknown failure mode may include applying the received signals and/or the identified segment to a machine learning algorithm 1124 configured to determine a mode of failure of the moving element. According to some embodiments, the machine learning algorithm 1124 may be trained to identify a potential failure mode of the identified segment.

According to some embodiments, at step 1004 of FIG. 10, the method may include identifying at least one change in the received signals and/or the at least one identified segment. According to some embodiments, the method may include applying the received signals and/or the at least one identified segment to a change detection algorithm such as for example, change detection algorithm 1108, configured to detect (or identify) at least one change in the received signals and/or the at least one identified segment.

According to some embodiments, identifying at least one change in the signals includes identifying a change in the rate of change in the signals. For example, the algorithm may be configured to identify a change that occurs periodically within the analyzed signals, then the analyzed signals may “return” to the previous state (e.g., prior to the change in the analyzed signals). According to some embodiments, the algorithm may be configured to identify a change in the rate of occurrence of the identified change.

According to some embodiments, the term “analyzed signals” as used herein may describe any one or more of the received signals, such as raw signals from the one or more optical sensor, processed or pre-processed signals from the one or more optical sensor, one or more images, one or more packets of images, one or more portions of one or more images, one or more videos, one or more portions of one or more videos, at least one identified segment, at least a portion of an identified segment, or any combination thereof. According to some embodiments, identifying the at least one change in the analyzed signals may include analyzing raw data of the received signals.

According to some embodiments, the change detection algorithm 1108 may include any one or more of a binary change detection, a quantitative change detection, and a qualitative change detection.

According to some embodiments, the binary change detection may include an algorithm configured to classify the analyzed signals as having a change or not having a change. According to some embodiments, the binary change detection may include an algorithm configured to compare two or more of the analyzed signals. According to some embodiments, for a comparison that shows the compared analyzed signals are the same, or essentially the same, the classifier labels the analyzed signals as having no detected (or identified) change. According to some embodiments, for a comparison that shows the compared analyzed signals are different, the classifier labels the analyzed signals as having a detected (or identified) change. According to some embodiments, two or more analyzed signals that are different may have at least one pixel that is different. According to some embodiments, two or more analyzed signals that are the same may have identical characteristics and/or pixels. According to some embodiments, the algorithm may be configured to set a threshold number of different pixels above which two analyzed signals may be considered as different.

Advantageously, the change detection algorithm 1108 enables fast detection of changes in the analyzed signaling and may be very sensitive to the slightest changes therein. Even more so, the detection and warning of the binary change detection may take place within a single signal, e.g., within a few milliseconds, depending on the signal outputting rate of the optical sensor, or for an optical sensor comprising a camera, a within a single image frame, e.g., within a few milliseconds, depending on the frame rate of the camera.

According to some embodiments, the binary change detection algorithm may, for example, analyze the analyzed signals and determine if a non-black pixel changes to black over time, thereby indicating a possible change in the position of the moving element, perhaps due to deformation or due to a change in the position of other components associated with the moving element. According to some embodiments, if the binary change detection algorithm detects a change in the signals, a warning signal (or alarm) may be generated in order to alert the equipment or a technician that maintenance may be required.

According to some embodiments, the binary change detection algorithm may be configured to determine the cause of the identified change using one or more machine learning models. According to some embodiments, the method may include determining the cause of the identified change by applying the identified change to a machine learning algorithm. For example, for a black pixel that may change over time (or throughout consecutive analyzed signals) to a color other than black, the machine learning algorithm may output that the change is indicative of a change in the material of the moving element, for example, due to overheating. According to some embodiments, the method may include generating a signal, such as an informational signal or a warning signal, if necessary. According to some embodiments, the warning signal may be a one-time signal or a continuous signal for example, that might require some form of action in order to reset the warning signal.

According to some embodiments, the method may include identifying the at least one change in the signals by analyzing dynamic movement of the moving element. According to some embodiments, the dynamic movement may include any one or more of linear movement, rotational movement, periodic (repetitive) movement, arced movement or any combination thereof.

According to some embodiments, the change detection may include a quantitative change detection. According to some embodiments, the quantitative change detection may include an algorithm configured to determining whether a magnitude of change above a certain threshold has occurred in the analyzed signals. According to some embodiments, the magnitude of change above a certain threshold may include a cumulative change in magnitude regardless of time, and/or a rate (or rates) of change in magnitude. For example, the value reflecting a change in magnitude may represent a number of pixels that have changed, a percentage of pixels that have changed, a total difference in the numerical values of one or more pixels within the field of view (or the analyzed signals), combinations thereof and the like. According to some embodiments, the quantitative change detection algorithm may output quantitative data associated with the change in the analyzed signals.

According to some embodiments, the change detection may include a qualitative change detection algorithm. According to some embodiments, the qualitative change detection algorithm may include an algorithm configured to classify the analyzed signals as depicting a change in the moving element. According to some embodiments, the qualitative change detection algorithm may include a machine learning model configured to receive the analyzed signals and to classify the analyzed signals into categories including at least: including a change in the behavior of the moving element, and not including a change in the behavior of the moving element.

According to some embodiments, the change detection algorithm may be configured to analyze, with the assistance of a machine learning model, other more complex changes in the analyzed signals generated by the optical sensors. According to some embodiments, the machine learning model may be trained to recognize complex, varied changes. According to some embodiments, the machine learning model may be able to identify complex changes, such as, for example, for signals generated by the optical sensors that may begin to exhibit some periodic instability, such that the signals can appear normal for a time, and then abnormal for a time before appearing normal once again. Subsequently, the signals may exhibit some abnormality that is similar but different than before, and the change detection algorithm may be configured to analyze changes and, over time, train itself to detect the likely cause of the abnormality. According to some embodiments, the change detection algorithm may be configured to generate a warning signal or an informational signal, if necessary, for a user to notice the changes in the moving element.

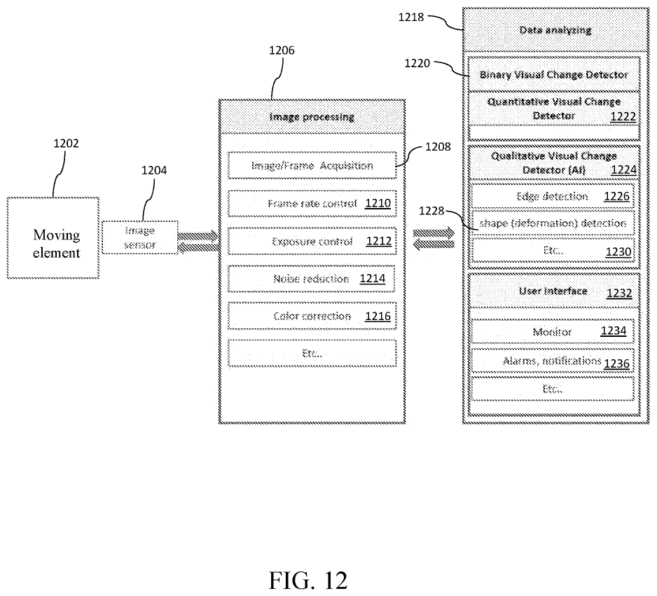

Reference is made to FIG. 12, which is a schematic block diagram of the system for monitoring potential failure in a moving element, optionally secured at least at one end thereof to an element stationary with regards to the movement and/or rotation of the moving element, in accordance with some exemplary embodiments of the present invention.

As depicted in the exemplary system of FIG. 12, the optical sensor may receive one or more signals from the moving element, such as, for example, moving element 1202. According to some embodiments, the optical sensor may generate signals, such as, for example, images or video, and send the generated signals to an image processing module 1206. According to some embodiments, the image processing module processes the signals generated by the optical sensor (or the image sensor 1204 of FIG. 12), such that the data can be analyzed by the data analysis module 1218 (or algorithms 910 as described herein). According to some embodiments, the image processing module 1206 may include any one or more of an image/frame acquisition module 1208, a frame rate control module 1210, an exposure control module 1212, a noise reduction module 1214, a color correction module 1216, and the like. According to some embodiments, the data analysis module (or algorithms 910 as described herein) may include the change detection algorithm such as for example, change detection algorithm 1108. According to some embodiments, the user interface module 1232 (described below) may issue any warning signals resulting from the signal analysis performed by the algorithms. According to some embodiments, any one or more of the signals, and/or the algorithms, may be stored on a cloud storage. According to some embodiments, the processor may be located on a cloud, such as, for example, cloud computing, which may co-exist with an embedded processor.

According to some embodiments, the data analyzing module 1218 may include any one or more of a binary (visual) change detector 1220 (or binary change detection algorithm as described in greater detail elsewhere herein), quantitative (visual) change detector 1222 (or quantitative change detection algorithm as described in greater detail elsewhere herein), and/or a qualitative (visual) change detector 1224 (or qualitative change detection algorithm as described in greater detail elsewhere herein). According to some embodiments, the qualitative (visual) change detector 1224 may include any one or more of edge detection 1226 and/or shape (deformation) detection 1228. According to some embodiments, the data analyzing module 1218 may include and/or be in communication with the user interface module 1232. According to some embodiments, and as described in greater detail elsewhere herein, the user interface module 1232 may include a monitor 1234. According to some embodiments, the user interface module 1232 may be configured to output the alarms and/or notifications 1236/1126.

According to some embodiments, the change detection algorithm such as for example, change detection algorithm 1108, may be implemented on an embedded processor, or a processor in the vicinity of the optical sensor. Thus, the change detection algorithm such as for example, change detection algorithm 1108, may enable a quick detection and prevent lag time associated with sending data to a remote server (such as a cloud).

According to some embodiments, once a change is identified using the change detection algorithm, the identified change may be classified using a classification algorithm. According to some embodiments, at step 1006, the method may include analyzing the identified change in the received signals (or the analyzed signals) and classifying whether the identified change in the received signals is associated with a mode of failure of the moving element, thereby labeling the identified change as a fault. According to some embodiments, the method may include applying the received signals (or the analyzed signals) to an algorithm configured to analyze the identified change in the received signals and to classify whether the identified change in the received signals is associated with a mode of failure of the moving element based, at least in part, on the obtained data.

According to some embodiments, the method may include applying the identified change to an algorithm configured to match between the identified change and the obtained data associated with the mode of failure. According to some embodiments, the algorithm may be configured to determine whether the identified change may potentially develop into one or more modes of failure. According to some embodiments, the algorithm may be configured to determine whether the identified change may potentially develop into one or more modes of failure based, at least in part, on the obtained data. According to some embodiments, the method may include labeling the identified change as a fault if the algorithm determines that that identified change may potentially develop into one or more modes of failure.

For example, an identified change of a surface defect and/or cut may be identified as a fault once the cut or defect reaches a certain size or length and may be associated with a mode of failure that is a critical cut size or critical defect size.

For example, where an identified change may include a texture or color of the moving element, the fault may be identified as corrosion, and the mode of failure may be an amount of corrosion or depth of corrosion within the moving element.

According to some embodiments, the fault may include any one or more of structural damage, a cut, a defect, a predetermined cut size and/or length, cut growth rate, cut propagation, fracture, defect diameter, warping, inflation, deformation, abrasion, wear, corrosion, oxidation, sparks, smoke, fluid flow rate, drop formation, drop size, fluid or drop volume, rate of drop formation, rate of accumulation of liquid, change in texture, change in color/shade, size of formed bubbles, puddle forming, puddle propagation, a change in dimension of at least a portion of the segment, a change in position of at least a portion of the segment, a change in color of at least a portion of the segment, a change in texture of at least a portion of the segment, change in size of at least a portion of the segment, a change in appearance of at least a portion of the segment, linear movement of at least a portion of the segment, rotational movement of at least a portion of the segment, periodic (repetitive) movement of at least a portion of the segment, a change in the rate of movement of at least a portion of the segment, lack of lubrication, over lubrication, diameter changes, signs of abrasion, signs of wear, improper alignment, groove problems, or any combination thereof.

According to some embodiments, the algorithm may identify the fault using one or more machine learning models. According to some embodiments, and as described in greater detail elsewhere herein, the machine learning model may be trained over time to identify one or more faults. According to some embodiments, the machine learning models may be trained to identify previously unknown faults by analyzing a baseline behavior of the moving element.

Advantageously, identifying the fault using a machine learning model enables the detection of different types of faults, or even similar faults that may appear different in different machinery or situations, or even different angles of the optical sensors. Thus, the machine learning model may increase the sensitivity of the detection of the one or more faults.

According to some embodiments, the system and/or the one or more algorithms may include one or more suppressor algorithms 1110 (also referred to herein as suppressors 1110). According to some embodiments, the one or more suppressor algorithms may be configured to classify whether the detected fault may develop into a failure or not, such as depicted by the mode of failure junction 1112 of FIG. 11. According to some embodiments, the one or more suppressor algorithms 1110 may include one or more machine learning models 1120. According to some embodiments, the one or more suppressor algorithms 1110 may classify a fault and/or a propagating fault as harmless.

According to some embodiments, at step 1008, for an identified fault, the method may include outputting a signal, such as a warning signal, indicative of the identified change being associated with the mode of failure. According to some embodiments, the method may include storing the identified change in the database, thereby increasing the data set for training the one or more machine learning models.

According to some embodiments, the method may include labeling data associated with any one or more of the modes of failure identification 1106, change detection algorithm 1108, the suppressors 1110, and the classification as depicted by the mode of failure junction 1112. According to some embodiments, the method may include supervised labeling 1116, such as manual labeling of the data using user input (or expert knowledge).

According to some embodiments, if the identified change is not classified as being associated with a mode of failure (such as depicted by arrow 1150 of FIG. 11), it may be identified (or classified) as normal, or in other words, normal behavior or operation of the moving element. According to some embodiments, for an identified change classified as normal, the method may include storing data associated with the identified change, thereby adding the identified change to the database and increasing the data set for training 1118 the one or more machine learning models (such as, for example, the one or more machine learning models 1120/1122/1124). According to some embodiments, the method may include using data associated with the identified change for further investigation, wherein the further investigation includes at least one of adding a mode of failure, updating the algorithm configured to identify the change, and training the algorithm to ignore the identified change in the future, thereby improving the algorithm configured to identify the change.

According to some embodiments, if the identified change is classified as being associated with a mode of failure (such as depicted by arrow 1155 of FIG. 11), the method may include trend analysis and failure prediction 1114. According to some embodiments, at step 1010, the method may include generating at least one model of a trend in the identified fault. According to some embodiments, the method may include generating at least one model of the trend based on a plurality of analyzed signals. According to some embodiments, the method may include generating at least one model of the trend by calculating the development of the identified change within the analyzed signals over time. According to some embodiments, the trend may include a rate of change of the fault. According to some embodiments, the method may include generating the at least one model of trend in the identified fault by calculating a correlation of the rate of change of the fault with one or more environmental parameters. According to some embodiments, the one or more environmental parameters may include any one or more of temperature, season or time of the year, pressure, time of day, hours of operation of the moving element, duration of operation of the moving element, an identified user of the moving element, mode of operation of the moving element, or any combination thereof.

According to some embodiments, the mode of operation of the moving element may include any one or more of the frequency of motion, the velocity of motion, the power consumption during operation, the changes in power consumption during operation, and the like. According to some embodiments, generating the at least one model of trend in the identified fault by calculating a correlation of the rate of change of the fault with one or more environmental parameters may include taking into account the different influences in the surrounding of the moving element. According to some embodiments, the method may include mapping the different environmental parameters effecting the operation of the moving element, wherein the environmental parameters may vary over time.

According to some embodiments, at step 1012, the method may include alerting a user of a predicted failure based, at least in part, on the generated model. According to some embodiments, the method may include outputting notifications and/or alerts 1126 to the user. According to some embodiments, the method may include alerting a user of the predicted failure. According to some embodiments, the method may include alerting the user of a predicted failure by outputting any one or more of: a time (or range of times) of a predicted failure and characteristics of the mode of failure, or any combination thereof. According to some embodiments, the method may include outputting a prediction of when the identified fault is likely to lead to failure in the moving element, based, at least in part, on the generated model. According to some embodiments, the predicting of when a failure is likely to occur in the moving element may be based, at least in part, on expected future environmental parameters. According to some embodiments, the predicting of when a failure is likely to occur in the moving element may be based, at least in part, on a known schedule, such as, for example, a calendar.

According to some embodiments, the system for monitoring potential failure in a moving element, such as, for example, system 900, may include one or more light sources configured to illuminate at least a portion of the vicinity of the moving element. According to some embodiments, the one or more light sources may include any one or more of a light bulb, light-emitting diode (LED), laser, a fiber light source, fiber optic cable, and the like. According to some embodiments, the user may input the location (or position) of the light source, the direction of illumination of the light source (or in other words, the direction at which the light is directed), the duration of illumination, the wavelength, the intensity, and/or the frequency of illumination of the light source in relation to the one or more optical sensor. According to some embodiments, the one or more algorithms may be configured to automatically locate the one or more light sources. According to some embodiments, the one or more algorithms may instruct the operation mode of the one or more light sources. According to some embodiments, the one or more algorithms may instruct and/or operate any one or more of the illumination intensities of the one or more light sources, the number of powered light sources, the position of the powered light sources, and the wavelength, the intensity, and/or the frequency of illumination of the one or more light sources, or any combination thereof.

Advantageously, an algorithm configured to instruct and/or operate the one or more light sources may increase the clarity of the received signals by reducing darker areas (such as, for example, areas from which light is not reflected and/or areas that were not illuminated) and may fix (or optimize) the saturation of the received signals (or images).

According to some embodiments, the one or more algorithms may be configured to detect and/or calculate the position in relation to the one or more optical sensors, the duration of illumination, the wavelength, the intensity, and/or the frequency of illumination of the one or more light sources. According to some embodiments, the one or more algorithms may be configured to detect and/or calculate the position in relation to the one or more optical sensors, the duration of illumination, the wavelength, the intensity, and/or the frequency of illumination of the one or more light sources based, at least in part, on the analyzed signals. According to some embodiments, the processor may control the operation of the one or more light sources. According to some embodiments, the processor may control any one or more of the duration of illumination, the wavelength, the intensity, and/or the frequency of illumination of the one or more light sources.

According to some embodiments, the method may include obtaining the position, the duration of illumination, the wavelength, the intensity, and/or the frequency of illumination, of the one or more light sources in relation to the one or more optical sensors. According to some embodiments, the method may include obtaining the position of the one or more light sources via any one or more of a user input, detection, and/or using the one or more algorithms. According to some embodiments, the method may include classifying whether the identified change in the (analyzed) signals is associated with a mode of failure of the moving element is based, at least in part, on any one or more of the placement(s) of the at least one light source, the duration of illumination, the wavelength, the intensity, and the frequency of illumination.

According to some embodiments, the method may include outputting data associated with an optimal location for placement (or location) of the optical sensor, from which potential modes of failure can be detected. According to some embodiments, the one or more algorithms may be configured to calculate at least one optimal location for placement (or location) of the one or more optical sensor, based, at least in part, on the obtained data, data stored in the database, and/or user inputted data.

According to some embodiments, the light source may illuminate the moving element with one or more wavelengths from a wide spectrum range, visible and invisible.

According to some embodiments, the light source may include a strobe light, or a light source configured to illuminate in short pulses. According to some embodiments, the light source may be configured to emit strobing light without the use of global shutter sensors.

According to some embodiments, the wavelengths may include any one or more of light in the ultraviolet region, the infrared region, or a combination thereof. According to some embodiments, the one or more light sources may be mobile, or moveable. According to some embodiments, the one or more light sources may change the outputted wavelength during operation, change the direction of illumination during operation, changes one or more lenses, and the like. According to some embodiments, the light source may be configured to change the lighting using one or more fiber optics (FO), such as, for example, by using different fibers to produce the light at different times, or by combining two or more fibers at once. According to some embodiments, the fiber optics may include one or more light sources attached thereto, such as, for example, an LED. According to some embodiments, the light intensity and/or wavelength of the LED may be changed, as described in greater detail elsewhere herein, using one or more algorithms.

Advantageously, illuminating the moving element may enable the optical sensor to detect faults and/or surface defects and/or structural defects by analyzing shadows and/or reflections. For example, a surface defect may generate a shadow that can be analyzed by the one or more algorithms and detected as a surface defect.

Advantageously, illuminating the moving element to detect surface defects while receiving the optical signals from the one or more optical sensors may enable detection of defects and/or faults that may not be visible to a human. According to some embodiments, the size of the defects and/or faults may range between 10 micrometers and 5 mm. According to some embodiments, the size of the defects and/or faults may be less than 10 micrometers. According to some other embodiments, the size of the defects and/or faults may be more than 5 mm.

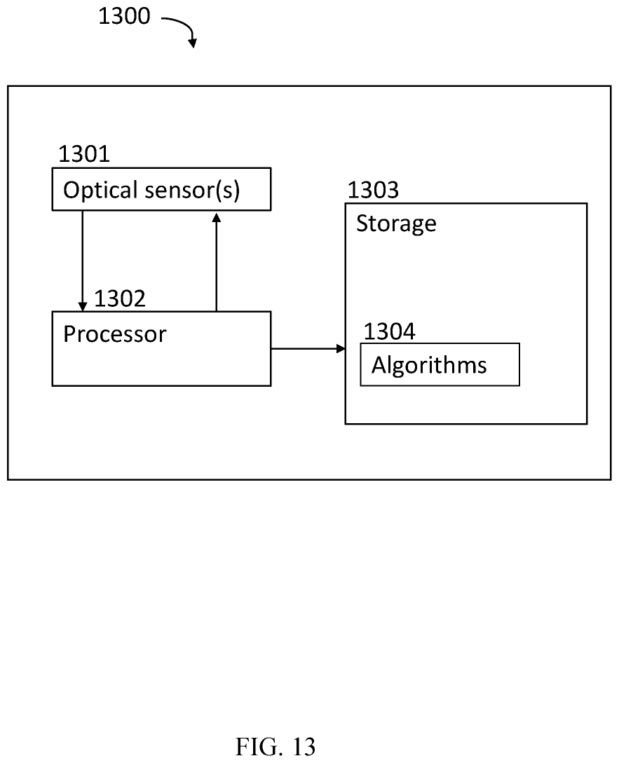

Reference is now made to FIG. 13, which is a simplified block diagram of a system for monitoring condition and/or integrity of operation of a moving element, optionally secured at least at one end thereof to an element stationary with regards to the movement and/or rotation of the element, according to some exemplary embodiments of the invention. System 1300 includes at least one optical sensor 1301, a processor 1302, and a storage module 1303 which is configured to store algorithms 1304 (such as faults detection algorithms) for processor 1302 to execute. The at least one optical sensor 1301 is configured to be fixed on, in vicinity to, and/or in sight with moving element and is configured to capture a plurality of images of the moving element while in motion. Processor 1302 is configured to be in communication with the at least one optical sensor and is executable to receive the captured plurality of images from the at least one optical sensor 1301. Processor 1302 is executable to calculate a maximal amplitude of a secondary motion of the moving element and/or displacement of the moving element along an axis which is perpendicular to the motion axis and/or the axial and radial motion of the moving element and/or combination thereof. If the maximal amplitude of the secondary motion and/or displacement of the moving element is above a predefined threshold, processor 1302 is executable to output a signal indicative of a fault in the moving element or associated with the moving element.

According to some embodiments one possibility to calculate the maximal amplitude of a secondary motion of the moving element and/or displacement of the moving element along an axis which is perpendicular to the motion axis and/or the axial and radial motion of the moving element and/or combination thereof, may be by measuring in each of the plurality of images a contour, perimeter and structure of traces formed along the movement of the moving element, and calculating a maximal deviation of the traces from a known base line of the traces when operating properly. For example, according to some embodiments at least one optical sensor 1301 may be configured to be set with a relatively long shutter exposure time such that a motion blur appears in the plurality of images of the moving and/or rotating moving element, as a result of the element motion. The motion blur which appears at the axis which is perpendicular to the element motion and/or along the axial and radial motion of the moving element represent the movement of the moving and/or rotating moving element due to the condition and/or integrity of operation of the moving element, the larger is the blur in the axis which is perpendicular to the axis of the element movement, the stronger is the indication of a fault or problem in the condition and/or integrity of operation of the moving element. Processor 1302 is executable to calculate a maximal deviation of the blur from a known base line of a blur formed when capturing images of the moving and/or rotating moving element when operating properly and if the deviation exceeds a predefined threshold processor 1302 is configured to output a signal indicative of a fault in the moving element or associated with the moving element.

According to some embodiments, another possibility to calculate the maximal amplitude of a secondary motion of the moving element and/or displacement of the moving element along an axis which is perpendicular to the motion axis and/or the axial and radial motion of the moving element and/or combination thereof, may be by utilizing an illumination source which configured to illuminate the moving element with a pulse of light during the capturing of the plurality of images, while the pulse duration is shorter than the shutter exposure time of the at least one sensor 1301. In this case, processor 1302 is executable to calculate a maximal amplitude of a secondary motion of the moving element and/or frequency of a secondary motion of the moving element and/or displacement of the moving element along the axis which is perpendicular to the motion axis and/or the axial and radial motion of the moving element and/or combination thereof.

According to some embodiments, monitoring condition and/or integrity of operation of the moving and/or rotating moving element includes monitoring at least one member of: tension, tightness, integrity, concentration, straightness, stability, dynamic balance, frequency, symmetry, rigidity and/or alignment of the moving and/or rotating moving element.

According to some embodiments, the predefined threshold is based on a calculated maximal amplitude of a secondary motion of the looped moving element and/or displacement of the looped moving element along the axis which is perpendicular to the motion axis and/or the axial and radial motion of the looped moving element and/or combination thereof when operating properly.

According to some embodiments, the moving element may be secured at two ends thereof.

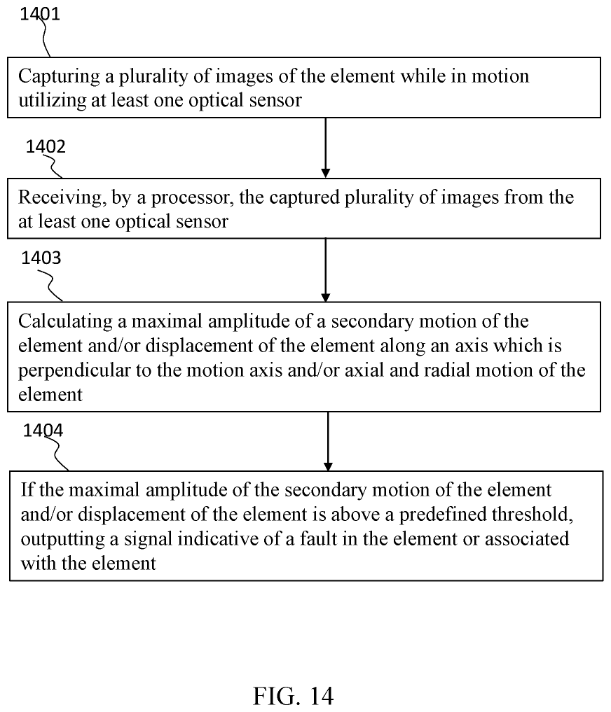

Reference is now made to FIG. 14 which is a simplified flowchart of a method for monitoring the condition and/or integrity of operation of a moving element, optionally secured at least at one end thereof to an element stationary with regards to the movement and/or rotation of the moving element, in accordance with some embodiments of the present invention. At step 1401 the at least one optical sensor is configured to capture a plurality of images of the moving element while in motion. At step 1402, the processor is configured to receive the plurality of images from the at least one optical sensor. At step 1403, the processor is executable to calculate a maximal amplitude of the secondary motion of the moving element and/or displacement of the moving element along an axis which is perpendicular to the motion axis of the moving element and/or combination thereof. At step 1404, if the maximal amplitude of the secondary motion of the moving element and/or displacement of the moving element is above a predefined threshold, the processor is executable to output a signal indicative of a fault in the moving element or associated with the moving element.

According to some embodiments, the moving element may be a belt which is connected between two pulleys. The belt may be a toothed belt, for example a timing belt or a flat belt.

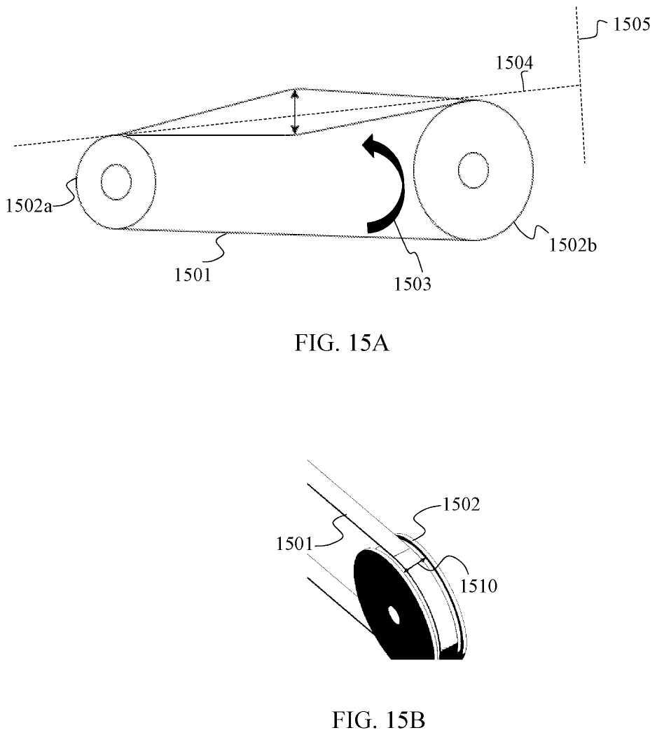

FIG. 15A is a simplified schematic illustration of a first example of monitoring the tightness and/or tension of a belt which is connected between two pulleys, according to some exemplary embodiments of the invention. Belt 1501 is connected between pulleys 1502a and 1502b (referred herein as pulleys 1502) and is moving between the two pulleys 1502 in a direction denoted by arrow 1503.

At least one optical sensor such as at least one sensor 1301 is configured to capture a plurality of images of belt 1501 in motion. A processor such as processor 602 is executable to receive the plurality of images and to calculate a maximal amplitude of a distance belt 1501 reaches in axis 1505 which is perpendicular to the motion axis 1504 of belt 1501. The distance is received as a result of a secondary motion of belt 1501 in axis 1505 created by looseness of belt 1501. According to some embodiments, the amplitude may be calculated by adding a maximal distance belt 1501 reaches along the positive direction of axis 1505 to a maximal distance belt 1501 achieves along the negative direction of axis 1505. For example, the amplitude may be calculated by measuring a motion blur created in each of the plurality of images due to the belt secondary motion in axis 1505 and adding the two maximal length of blur measured along the positive and negative directions of axis 1505. Another example for calculating the maximal amplitude of the distance belt 1501 reaches in axis 1505 may be by capturing the plurality of images while illuminating belt 1501 with pulses of light, such that the duration of the pulses are shorter than the shutter exposure time of the at least one optical sensor, thereby receiving sharp images of belt 1501, and calculating the maximal amplitude of the distance belt 1501 reaches by adding the a maximal distance the belt reaches along the positive direction of axis 1505 to a maximal distance belt 1501 reaches along the negative direction of axis 1505. After the maximal amplitude of the distance belt 1501 reaches is calculated, the processor is executable to compare the calculated amplitude to a predefined threshold to detect looseness of belt 1501. The predefined threshold is based on a known baseline of the blur of a belt created in one or more images when the belt is operating in a proper tension/tightness. If the maximal amplitude of the blur calculated is above the predefined threshold the processor is executable to output a signal indicative of the detected looseness of the belt.

According to some embodiments the belt may be a flat belt or a toothed belt such a timing belt.

According to some embodiments, a fault detected may be looseness of the belt, a misalignment between the two pulleys, or an asymmetry in the mechanism of the belt and the two pulleys.

A mode of failure of the belt may be a release of the belt or a critical level of looseness of the belt.

FIG. 15B is a simplified schematic illustration of a second example of monitoring the tightness and/or tension of a belt which is connected between two pulleys, according to some embodiments. In this case a displacement of belt 1501 on pulley 1502 is calculated along the axis denoted by arrow 1510.

If the amplitude of the displacement of belt 1501 is above a predefined threshold, the processor is executable to output a signal indicative of a detected fault for example looseness of belt 1501, a misalignment between the two pulleys, or an asymmetry in the mechanism of the belt and the two pulleys.

According to some embodiments, the moving element may be a shaft (for example the shafts of FIGS. 6G-6H). According to some embodiments, at least one sensor such as at least one sensor 1301 is configured to capture a plurality of images of a rotating shaft. The at least one sensor is set to be with a shutter exposure time that is longer than the shutter exposure time that is required to capture a sharp image or a frame per second (FPS) rate which is lower than the FPS rate that is required to capture a sharp image (for example a standard 30 or 60 or 120 FPS image sensor) such that a motion blur is created in the captured plurality of images of the shaft. In this exemplary embodiment, a processor such as processor 1302 is configured to calculate the amplitude of the blur of the shaft along the axial and radial motion of the shaft and to detect that the amplitude of the blur is above a predefined threshold, and therefore the processor is configured to output a signal indicative of the curvature detected in the shape of the shaft (e.g. at the end or in the middle of the shaft).

According to some embodiments the element may be a rotor, propeller, fan blades, impeller, turbine blade and/or turbo blade.

According to some embodiments the processor is further executable to apply on the plurality of images a set of faults detection algorithms to detect potential faults in the element or section thereof based on predefined faults detection parameters, and for a detected fault, output a signal indicative thereof.

According to some embodiments, the faults detection algorithms are configured to obtain data associated with the faults detection parameters of at least one mode of failure of the element. And identify at least one change in at least one image of the plurality of images in comparison to a given image of the element in a proper condition or in comparison to an image of the element previously obtained. For an identified change, apply the at least one identified change to an algorithm configured to analyze the identified change and to classify whether the identified change is associated with a mode of failure of the element, thereby labeling the identified change as a detected fault, based, at least in part, on the obtained data, and for an identified change which is classified as being associated with a mode of failure, outputting a signal indicative of the identified change associated with the mode of failure.

According to some embodiments, for a detected fault, the processor is executable to generate at least one model of a trend in the identified fault. The trend may include a rate of change in the fault. According to some embodiments, generating the at least one model of trend in the detected fault includes calculating a correlation of the rate of change of the fault with one or more environmental parameters.

According to some embodiments, the processor is further configured to alert a user of a predicted failure based, at least in part, on the generated model. According to some embodiments, alerting the user of a predicted failure comprises any one or more of a time (or range of times) of a predicted failure, a usage time of the element and characteristics of the mode of failure, or any combination thereof.

### General

The terms “comprises”, “comprising”, “includes”, “including”, “having” and their conjugates mean “including but not limited to”.

The term “consisting of” means “including and limited to”.

As used herein, singular forms, for example, “a”, “an” and “the” include plural references unless the context clearly dictates otherwise.

Within this application, various quantifications and/or expressions may include use of ranges. Range format should not be construed as an inflexible limitation on the scope of the present disclosure. Accordingly, descriptions including ranges should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within the stated range and/or subrange, for example, 1, 2, 3, 4, 5, and 6. Whenever a numerical range is indicated within this document, it is meant to include any cited numeral (fractional or integral) within the indicated range.

It is appreciated that certain features which are (e.g., for clarity) described in the context of separate embodiments, may also be provided in combination in a single embodiment. Where various features of the present disclosure, which are (e.g., for brevity) described in a context of a single embodiment, may also be provided separately or in any suitable sub-combination or may be suitable for use with any other described embodiment. For example, methods, sensors, illumination, processing circuitry described with some embodiments may be used with other embodiments as well. Features described in the context of various embodiments are not to be considered essential features of those embodiments, unless the embodiment is inoperative without those elements.

Although the present disclosure has been described in conjunction with specific embodiments thereof, it is evident that many alternatives, modifications, and variations will be apparent to those skilled in the art. Accordingly, this application intends to embrace all such alternatives, modifications and variations that fall within the spirit and broad scope of the appended claims.

All references (e.g., publications, patents, patent applications) mentioned in this specification are herein incorporated in their entirety by reference into the specification, e.g., as if each individual publication, patent, or patent application was individually indicated to be incorporated herein by reference. Citation or identification of any reference in this application should not be construed as an admission that such reference is available as prior art to the present disclosure. In addition, any priority document(s) and/or document(s) related to this application (e.g., co-filed) are hereby incorporated herein by reference in its/their entirety.

Where section headings are used in this document, they should not be interpreted as necessarily limiting.

1.-55. (canceled)

56. A system for monitoring a moving element, comprising a processing circuitry configured to:
input image data of at least one section of a moving element from at least one optical sensor;
determine, from said image data, a range of motion of said at least one section of said moving element in a secondary direction of motion relative to a primary direction of motion of said moving element; and
output an indicator of a health of said moving element based on an analysis of said range of motion.

57. The system of claim 56, wherein said moving element comprises a rotating moving element, said primary direction of motion comprises a rotational direction of motion and said secondary direction of motion comprises a linear direction of motion.

58. The system of claim 56, wherein said moving element comprises a looped moving element, said primary direction of motion comprises a first longitudinal direction of motion of said looped moving element and said secondary direction of motion comprises a second longitudinal direction of motion transverse to said first longitudinal direction of motion.

59. The system of claim 58, wherein said looped moving element comprises one of:
a pulley belt;
a cable;
a strap;
a rope; and
a chain.

60. The system of claim 56, wherein said indicator is output to a controller configured to control an operation of said moving element based on said health of said moving element, so as to prevent operation of said moving element during failure.

61. The system of claim 56, wherein said indicator is output to a preventive maintenance system configured to provide maintenance instructions based on said indicator.

62. The system of claim 56, wherein said indicator is displayed on a user interface so as to alert a user of said health of said moving element.

63. The system of claim 56, wherein said indicator comprises at least one of:
maintenance instructions;
a time to failure estimation;
a failure alert; and
operating instructions in response to a detected failure.

64. The system of claim 56, wherein said analysis comprises evaluating said health of said moving element by comparing a magnitude of said range of motion to at least one threshold.

65. The system of claim 56, wherein said processing circuitry determines said range of motion by calculating a maximal amplitude of a contour of said moving element in an image captured with an exposure time exceeding an expected time for said moving element to transition over an entire range of motion and, wherein said exposure time is selected so as to blur said moving element within said image data.

66. The system of claim 65, wherein said processing circuitry is further configured to control said optical sensor to capture said image with said exposure time exceeding an expected time for said moving element to transition over said entire range of motion.

67. The system of claim 56, wherein said processing circuitry determines said range of motion based on a statistical analysis of a sequence of image frames.

68. The system of claim 56, wherein said processing circuitry is configured to evaluate said health of said moving element based on a change of a magnitude of said range of motion over time.

69. The system of claim 56, wherein said processing circuitry is configured to evaluate said health of said moving element based on changes in a shape of said moving element in a plurality of different sections of said moving element.

70. The system of claim 56, wherein said processing circuitry is configured to input image data from a plurality of optical sensors, each of said optical sensors capturing image data of a respective section of said moving element.

71. The system of claim 56, wherein said processing circuitry is configured to input image data from a single optical sensor at a fixed location relative to said moving element.

72. The system of claim 56, wherein at least one of said sections of said moving element comprises at least 10% of a length of said moving element.

73. The system of claim 56, wherein said analysis is based on a machine learning model trained using a training set of images collected during operation of at least one of said moving element and a similar moving element.

74. The system of claim 56, wherein said analysis comprises predicting a future health of said moving element by performing trend analysis on changes in said range of motion over time.

75. A computer-implemented method for monitoring a moving element, the method comprising:
receiving, by at least on processor, image data of at least one section of a moving element from at least one optical sensor;
determining, by the at least one processor, from said image data, a range of motion of said at least one section of said moving element in a secondary direction of motion relative to a primary direction of motion of said moving element; and
outputting, by the at least one processor, an indicator of a health of said moving element based on an analysis of said range of motion
